(19) United States
(12) Patent Application Publication
(10) Pub. No.: US 2013/0062363 A1
(43) Pub. Date: Mar. 14, 2013

(54) Tablet Cassette

(71) Applicants: Shoji Yuyama, Osaka (JP); Naoki Koike, Osaka (JP); Akira Maeda, Osaka (JP)

(72) Inventors: Shoji Yuyama, Osaka (JP); Naoki Koike, Osaka (JP); Akira Maeda, Osaka (JP)

(73) Assignee: YUYAMA MFG. CO., LTD., Osaka (JP)

(21) Appl. No.: 13/697,467

(22) PCT Filed: May 10, 2011
(86) PCT No.: PCT/JP2011/060694

§ 371 Date: Nov. 12, 2012

(30) Foreign Application Priority Data
May 17, 2010 (JP) 2010-113718
Jul. 16, 2010 (JP) 2010-161999

(51) Int. Cl. G07F 11/44

(52) U.S. Cl. CPC G07F 11/44
USPC 221/82

(57) ABSTRACT

A vertical position and an entrance depth of a partitioning member are easily adjusted in accordance with the size of a tablet to be dispensed. Further, a rotor is easily demounted from a securement member fixed to a drive shaft. A side wall of a cassette body is formed with a plurality of slits, through which at least one elastic bristle penetrates, along a circumferential direction of the rotor. The slits extend in an axial direction of the rotor. A partitioning member is movable along the slit with the elastic bristle penetrating through the slit. When a cap is downwardly pressed, a pressing portion presses a flexible portion to thereby release the engagement between the flexible portion and an engagement portion and an elastic force of an arm portion urges a rotor upwardly.

### CROSS-REFERENCE TO RELATED APPLICATIONS

This application is a 35 U.S.C §371 National Stage of International Application No. PCT/JP2011/060694 filed on May 10, 2011, which claims priority to Japanese Patent Application No. 2010-113718 filed on May 17, 2010 and Japanese Patent Application No. 2010-161999 filed on Jul. 16, 2010.

### TECHNICAL FIELD

The present invention relates to a tablet cassette that is disposed in a tablet storing and dispensing apparatus and receives a large number of tablets per each type and dispenses a required number of tablets in accordance with prescription.

### BACKGROUND

Patent Document 1 describes a tablet cassette configured as follows: a rotatably-driven rotor is disposed in a bottom of a cassette body; an outer peripheral surface of the rotor is formed with a plurality of axial guide grooves and with a circumferential circumference groove; the guide groove is brought into communication with a tablet outlet formed in the bottom of the cassette body; a partitioning member is attached to an outer surface of the cassette body to enter the circumference groove of the rotor; a lower tablet and another tablet located thereabove, which are introduced to the guide groove, are divided from each other by the partitioning member; and only the lower tablet is dispensed from the tablet outlet. Further, Patent Document 4 describes that the same partitioning member is inserted to an insertion hole of a cassette body and is fixed by a cover. The aforementioned tablet cassettes need to use the rotors that have different guide grooves in accordance with the sizes of tablets. Further, the aforementioned tablet cassettes need to change the attachment position of the partitioning member.

Thus, various proposals have been made for purposes of dispensing a plurality of types of variously-sized tablets from the same tablet cassette.

Patent Document 2 discloses a tablet cassette configured as follows: a rotor includes a core body and an outer cylindrical body attachable to and detachable from the core body; outer cylindrical bodies having a guide groove having different width and depth are replaceable in accordance with the size of the tablet to be dispensed; a partitioning member is upward and downward movable by tightening or loosening a bolt; and the position of the partitioning member is changed in accordance with the size of the tablet to be dispensed. However, the above-described configuration is complicated because it requires two tasks, i.e., replacement of the outer cylinder body and replacement and attachment of the partitioning member.

Further, Patent Document 2 discloses that a ring body is fitted between the outer surface of the rotor and the inner surface of the cassette body to narrow a cross-section of the guide groove, and that a groove-depth adjuster is radially movably provided in a bottom of the guide groove so as to adjust the depth of the guide groove. However, the task of mounting or fixing the ring body is difficult and the task of moving and fixing the groove-depth adjuster is performed for each guide groove. Those tasks are complicated and time-consuming.

Patent Document 3 discloses the following configuration: a plurality of insertion holes are provided in a cassette body; and a partitioning member is fitted and fixed to the insertion hole located at a height corresponding to the size of a tablet. Further, Patent Document 3 discloses the following configuration: a plurality of insertion holes and positioning holes are provided; the partitioning member is inserted to the insertion hole located at a height corresponding to the size of a tablet; and a pin provided in the partitioning member is fitted to the positioning hole to fix the partitioning member. However, the above-described configuration is problematic since the entrance amount of the partitioning member to a guide groove cannot be adjusted.

As shown in FIG. 36, a prior art tablet cassette 300 has a rotatably-driven drive shaft 301 at a bottom of a cassette body. A rotor 303 is attached to the drive shaft 301 through a securement member 302. Specifically, claws 304a of elastic pieces, which project from a top of the securement member 302, engage a flange 306, which is formed at a lower edge of a central bore 305 of the rotor 303, thus rotatably mounting the rotor 303 to the securement member 302. Further, a cap 307 is screw-coupled to an upper portion of the central bore 305 and prevents tablets from entering the inside of the central bore 305. An outer peripheral surface of the rotor 303 of such a tablet cassette 300 is formed with a plurality of guide grooves 308 along a circumferential direction. As the rotor 303 rotates with the tablet cassette 300 filled with tablets, the tablets enter the guide groove 308. When the guide groove 308 is positioned above a tablet outlet (not shown in FIG. 36) formed in the bottom of the tablet cassette 300, the tablet introduced in the guide groove 308 is dispensed from the tablet outlet.

However, the tablet cassette 300 needs to replace the rotor with another rotor having a suitably-dimensioned guide groove 308 in accordance with the size of tablets to be received in the tablet cassette. Further, if the rotor 303 rotates with the tablet introduced in the guide groove 308, then the bottom of the tablet cassette 300 and the tablet are rubbed each other and thus powder lies on the bottom of the tablet cassette 300. Further, to prevent two or more tablets from entering one guide groove 300 side-by-side in a radial direction of the rotor 303, a distance from the tablet to the side surface of the tablet cassette 300 is slightly greater than the dimension of the tablet. Such a distance is for purposes of dispensing the tablet one at a time whenever the guide groove 308 is moved above the tablet outlet. If the rotor 303 rotates with the tablet introduced in the guide groove 308 as described above, then the tablet and the side surface of the tablet cassette 300 rub against each other and powder lies on the bottom of the tablet cassette 300. The powder, which has lied on the bottom of the tablet cassette 300 as described above, falls from the tablet outlet and then may be packaged together with the tablet. Therefore, to remove the powder, the rotor 303 needs to be demounted from the tablet cassette 300. To demount the rotor 303 from the securement member 302, the cap 307 is demounted from the rotor 303 and thereafter the elastic pieces 304 need to be inwardly pressed to release the engagement between the claws 304a and the flange 306. Therefore, it is problematic that the task of demounting the rotor 303 from the securement member 302 is complicated and time-consuming. Further, if the tablet cassette 300 is turned upside down in order to remove the rotor 303 from the tablet cassette 300, the powder falls from the bottom of the tablet cassette 300 or adheres to a human's hand. This is also problematic.
Patent Document 1: Japanese Laid-Open Patent Application No. Hei 9-39910
Patent Document 2: Japanese Laid-Open Patent Application No. Hei 8-164904
Patent Document 3: Japanese Laid-Open Patent Application No. 2005-247355
Patent Document 4: Korean Utility Model Registration No. 20-0438560

### SUMMARY

The present invention has been made in view of the foregoing problems in the prior art. It is an object of the present invention to provide a tablet cassette that is capable of easily adjusting a vertical position and an entrance depth of a partitioning member in accordance with the size of tablets to be dispensed. It is a further object of the present invention to provide a tablet cassette that is capable of preventing a partitioning member from being mounted in a right and left reversed manner and is capable of preventing rattling of the partitioning member.

It is yet another object of the present invention to provide a tablet cassette that allows a rotor to be easily demounted from a securement member fixed to a drive shaft and prevents powder from falling from a bottom of the tablet cassette or adhering to a human's hand.

As a first measure for achieving the foregoing object, there is provided a tablet cassette comprising: a cassette body formed with a tablet-receiving section for receiving a tablet; a rotor rotatably driven and disposed in a bottom of the tablet receiving section of the cassette body, an outer peripheral surface of the rotor formed with a plurality of guide grooves extending in an axial direction; and a partitioning member attached to the cassette body and entering the guide groove of the rotor that comes to a position where the guide groove communicates with a tablet outlet provided in the cassette body. The partitioning member has a partitioning portion comprising a plurality of elastic bristles and a side wall of the cassette body is formed with a plurality of slits, through which at least one of the elastic bristles penetrates, along a circumferential direction of the rotor. The slits extend in the axial direction of the rotor. The partitioning member is movable along the slit with the elastic bristle penetrating through the slit.

In the first measure, it is preferred that the side wall of the cassette body is formed with an opening facing toward the outer peripheral surface of the rotor and a closure member formed with the slits closes the opening.

Further, preferably, a retention member that movably retains the partitioning member in a radial direction of the rotor is provided. Preferably, the closure member is provided with a support portion supporting the retention member. Preferably, the partitioning member is formed with an engaging portion and the retention member is formed with an engaged portion which the engaging portion of the partitioning member engages, thereby allowing suitable positioning in the radial direction of the rotor.

As a second measure, there is provided a tablet cassette comprising: a cassette body formed with a tablet receiving section for receiving a tablet; a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and a partitioning member attached to the cassette body and entering the guide groove of the rotor that comes to a position where the guide groove communicates with a tablet outlet provided in the cassette body. A side wall of the cassette body is formed with an opening facing toward the outer peripheral surface of the rotor and a plurality of closure pieces divided in the axial direction of the rotor closes the opening. One of the plurality of the closure pieces is formed with a slit extending in the circumferential direction of the rotor. A partitioning portion of the partitioning member is inserted to the slit. The closure piece with the slit formed therein is replaced with another closure piece and the partitioning portion of the partitioning member is inserted to the slit of the closure piece with the slit formed therein, thereby changing an attachment position.

In the second measure, preferably, a retention member that movably retains the partitioning member in a radial direction of the rotor is provided. Preferably, the closure member is provided with a support portion supporting the retention member. Preferably, the partitioning member is formed with an engaging portion and the retention member is formed with an engaged portion which the engaging portion of the partitioning member engages, thereby allowing suitable positioning in the radial direction of the rotor.

As a third measure, there is provided a tablet cassette comprising: a cassette body formed with a tablet receiving section for receiving a tablet; a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and a partitioning member attached to the cassette body and entering the guide groove of the rotor that comes to a position where the guide groove communicates with a tablet outlet provided in the cassette body. A side wall of the cassette body is formed with an opening facing toward the outer peripheral surface of the rotor and a plurality of closure pieces divided in the axial direction of the rotor and a single partitioning member close the opening. The partitioning member is replaced with one of the closure pieces, thereby changing an attachment position.

In the third measure, it is preferred that both side edges of the opening are formed with a groove, which both ends of the plurality of the closure pieces engage, and the partitioning member is insertable along the groove in a radial direction of the rotor.

Further, preferably, both ends of the partitioning member are inserted and attached to a first projecting portion and a second projecting portion, which are formed in a U-shaped cross-section by forming a groove therein. Both surfaces of the closure piece are formed with a ridge extending perpendicularly to an insertion direction of the closure piece and opposing surfaces of the grooves of the first projecting portion and the second projecting portion are formed with a plurality of engaging grooves, which the ridge engages, along the insertion direction of the closure piece.

Further, preferably, a plurality of the partitioning members, the respective partitioning portions of which have a different length, are prepared. Preferably, the partitioning member, which has the partitioning portion having a length according to a size of the tablet to be received in the cassette body, is selected and attached.

Further, preferably, a lid member, which closes a further outside of the plurality of the closure pieces and the partitioning member which are attached to the opening, is openably and closably attached to the cassette body. A backside of the closure piece is formed with a protrusion portion that interferes with an inner surface of the lid member when the closure piece is attached in a right and left reversed manner in a state other than a normal position and the lid member is closed.

Further, preferably, a backside of the closure piece is formed with a knob portion and a length of a first shoulder portion, which ranges from one end of the closure piece to one end of the knob portion, is different from a length of a second shoulder portion, which ranges from an opposite end of the closure piece to an opposite end of the knob portion. Preferably, the first projecting portion of the partitioning member has the same length as the length of the first shoulder portion of the closure piece and the second projecting portion of the partitioning member has the same length as the length of the second shoulder portion of the closure piece. Preferably, the first projecting portion and the second projecting portion of the partitioning member interfere with the knob portion of an adjacent closure piece when the partitioning member is attached in a state other than a normal position in a right and left reversed manner.

Further, preferably, backsides of the first projecting portion and the second projecting portion of the partitioning member are formed with a projection or recess. Preferably, a lid member, which closes a further outside of the plurality of the closure pieces and the partitioning member which are attached to the opening, is openably and closably attached to the cassette body. An inner surface of the lid member is formed with a recess or projection that engages the projection or recess of the partitioning member.

As a fourth measure, there is provided a tablet cassette comprising: a cassette body formed with a tablet receiving section for receiving a tablet; a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and a partitioning member attached to the cassette body and entering the guide groove of the rotor that comes to a position where the guide groove communicates with a tablet outlet provided in the cassette body. Preferably, a side wall of the cassette body is formed with a plurality of slits, to which a partitioning portion of the partitioning member is inserted, along the axial direction of the rotor. The slits extending in the circumferential direction of the rotor. Preferably, the partitioning portion of the partitioning member is inserted to one of the plurality of the slits, thereby changing an attachment position.

In the fourth measure, preferably, both side edges of the opening are formed with as many grooves as the slits and both ends of the partitioning member engage the groove. The partitioning member is insertable along the groove in a radial direction of the rotor.

Further, preferably, both ends of the partitioning member are inserted and attached to a first projecting portion and a second projecting portion, which are formed in a U-shaped cross-section by forming a groove therein. Preferably, both surfaces of the partitioning member are formed with a ridge extending perpendicularly to an insertion direction of the partitioning member and opposing surfaces of the grooves of the first projecting portion and the second projecting portion are formed with a plurality of engaging grooves, which the ridge engages, along the insertion direction of the partitioning member.

Further, preferably, a plurality of the partitioning members, the respective partitioning portions of which have a different length, are prepared and the partitioning member having the partitioning portion having a length according to a size of the tablet to be received in the cassette body is selected and attached.

Further, preferably, a protrusion portion is provided between the adjacent slits of the cassette body. Preferably, a length of a first shoulder portion, which ranges from one side edge of the cassette body to one end of the protrusion portion, is different from a length of a second shoulder portion, which ranges from an opposite side edge of the cassette body to an opposite end of the protrusion portion. Preferably, the first projecting portion of the partitioning member has the same length as the length of the first shoulder portion of the cassette body and the second projecting portion of the partitioning member has the same length as the length of the second shoulder portion of the cassette body. The first projecting portion and the second projecting portion of the partitioning member interfere with the protrusion portion of the cassette body when the partitioning member is attached in a state other than a normal position in a right and left reversed manner.

Further, preferably, backsides of the first projecting portion and the second projecting portion of the partitioning member are formed with a projection or recess. Preferably, a lid member, which closes a further outside of the slit of the cassette body, is openably and closably attached to the cassette body and an inner surface of the lid member is formed with a recess or projection that engages the projection or recess of the partitioning member.

As a fifth measure, there is provided a tablet cassette comprising: a cassette body formed with a tablet receiving section receiving a tablet; a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and a partitioning member attached to the cassette body and entering the guide groove of the rotor that comes to a position where the guide groove communicates with a tablet outlet provided in the cassette body. A side wall of the cassette body is formed with a plurality of slits, to which a partitioning portion of the partitioning member is inserted, along the axial direction of the rotor. The slits extend in the circumferential direction of the rotor. The tablet cassette further comprises: a retention member configured to retain the partitioning member and to adjust a retention position of the partitioning member so as to change an entrance depth of the partitioning member to the guide groove of the rotor; and an adjustment member configured to attach the retention member retaining the partitioning member and to adjust an attachment position of the partitioning member such that the partitioning portion of the partitioning member is inserted to one of the plurality of the slits to change a height of the partitioning member.

In the fifth measure, preferably, the partitioning member is provided with at least one pair of engaging portions extending in the axial direction of the rotor. Preferably, the retention member is formed with a plurality of engaged portions, which said at least one pair of engaging portions engage, along a direction perpendicular to the axial direction of the rotor.

Preferably, the side wall of the cassette body is formed with as many pairs of support grooves as the plurality of the slits. The support grooves extend in a direction perpendicular to the axial direction of the rotor. Preferably, the retention member is provided with a pair of projection tabs that slidably engage the support groove of the cassette body

Preferably, the retention member is provided with a projection portion and the adjustment member is formed with a plurality of mounting holes, which the projection portion of the retention member engages, along the axial direction of the rotor.

Preferably, the projection portion of the retention member comprises first and second projecting portions having a different shape and the mounting hole of the adjustment member comprises a first mounting hole and a second mounting hole, which the first projecting portion and the second projecting portion engage, respectively. Preferably, the first projecting portion and the second projecting portion engage the first mounting hole and the second mounting hole only when the retention member is in a predetermined orientation.

Preferably, the side wall of the cassette body is formed with a pair of guide grooves that extend in a direction perpendicular to the axial direction of the rotor and the adjustment member is provided with a pair of guide edges that slidably engage the guide groove. Preferably, the adjustment member is slidable relative to the cassette body between: an advance position where the partitioning member enters the guide groove of the rotor; and a retreat position where the partitioning member is retreated from the guide groove.

Preferably, the side wall of the cassette body is provided with an elastic piece having an engaging claw at a tip end and the adjustment member is provided with an engaging portion, which the engaging claw of the elastic piece engages when the adjustment member is in the advance position and the retreat position.

Further, in the above-described measures, it is preferred that the rotor is replaceable.

In order to achieve the foregoing object, the present invention provides a tablet cassette comprising: a cassette body formed with a tablet receiving section for receiving a tablet; and a rotor rotatably driven by a drive shaft disposed in a bottom of the tablet receiving section of the cassette body, the rotor having an engagement portion extending radially. The tablet cassette further comprises: a securement member fixed to the drive shaft, the securement member including: a drive portion transmitting a power of the drive shaft to the rotor to rotate the rotor; a flexible portion engaging the engagement portion; and an arm portion abutting the rotor in an elastically deformed state; and a cap attached to the rotor and movable in an axial direction of the rotor, the cap having a pressing portion that is downwardly pressed to thus press the flexible portion of the securement member. When the cap is downwardly pressed, the pressing portion presses the flexible portion to thereby release an engagement between the flexible portion and the engagement portion and an elastic force of the arm portion urges the rotor upwardly.

According to the above-described configuration, the rotor can be demounted from the securement member only by pressing the cap downwardly. In this case, since the elastic force of the arm portion urges the rotor upwardly, the rotor can be easily demounted without the need for turning upside down the tablet cassette in order to remove the rotor from the tablet cassette. Thus, powder can be prevented from falling from the bottom of the tablet cassette or adhering to a human's hand.

Preferably, the drive portion of the securement member comprises a projection portion extending upwardly from either end of the securement member and the engagement portion formed in the rotor comprises a concave section and a convex section that are alternately continuous. The projection portion engages the concave section. Thus, the drive power of the securement member can be reliably transmitted to the rotor.

Preferably, the arm portion of the securement member extends outwardly from a side edge of the securement member and has an upthrust portion upwardly standing from an end portion. Preferably, a pressed portion formed in the rotor is the convex section of the engagement portion of the rotor and the upthrust portion thrusts up the convex section.

Preferably, a center of the rotor is formed with a hole. Preferably, the engagement portion of the rotor comprises a flange protruding inwardly from a lower inner periphery of the hole and the pressing portion of the cap is formed in a lower end of a cylindrical portion that is provided coaxially with an axis of the rotor.

Preferably, a plurality of holes is formed around a center of the rotor. Preferably, the engagement portion of the rotor comprises a lower cutout portion formed at a lower edge of an inner peripheral surface of the hole and the pressing portion of the cap is formed at lower ends of a plurality of legs of the cap, which are inserted to the rotor.

It is preferred that an upper end portion of the cap is provided with a flange portion extending radially outwardly and the tablet cassette further comprises a holder that is formed with a protrusion engaging the flange portion from below. Thus, the rotor, which is demounted from the securement member, is lifted upward from the cassette body through the cap by means of the holder and then easily removed. This prevents the falling of the powder from the bottom of the tablet cassette or adhesion of the powder to a human's hand, which may occur when turning the cassette body upside down.

According to the first measure, since the position of the partitioning member can be adjusted by moving the partitioning member along the slit in the axial direction of the rotor, the vertical position of the partitioning member can be easily adjusted. Further, in an example wherein the retention member retaining the partitioning member is provided and the closure member is provided with the support portion supporting the retention member, the entrance depth of the partitioning member can be easily adjusted by moving the partitioning member relative to the retention member.

According to the second measure, the vertical position of the partitioning member can be easily adjusted by replacing the closure member formed with the slit with another closure member and inserting the partitioning portion of the partitioning member to the slit of the closure member formed with the slit. Further, in an example wherein the retention member retaining the partitioning member is provided and the lid member is provided with the support portion supporting the retention member is provided in the closure member, the entrance depth of the partitioning member can be easily adjusted by moving the partitioning member relative to the retention member.

According to the third measure, the vertical position of the partitioning member can be easily adjusted by replacing the closure member, to which the partitioning member is attached, with another closure member. Further, in an example wherein the partitioning member is provided with the first projecting portion and the second projecting portion, the entrance depth of the partitioning member can be easily adjusted by bringing one of a plurality of engaging grooves of the first and second projecting portions into engagement with the ridge of the partitioning member.

According to the fourth measure, the vertical position of the partitioning member can be easily adjusted by inserting the partitioning portion of the partitioning member to one of a plurality of the slits. Further, in an example wherein the partitioning member is provided with the first projecting portion and the second projecting portion, the entrance depth of the partitioning member can be easily adjusted by bringing one of a plurality of engaging grooves of the first and second projecting portions into engagement with the ridge of the partitioning member.

According to the fifth measure, the entrance depth of the partitioning member can be easily adjusted by bringing the engaging portion of the partitioning member into engagement with one of a plurality of the engaged portions of the retention member. Further, the height of the partitioning member can be easily adjusted by bringing the projection portions of the retention member into engagement with a plurality of the mounting holes of the adjustment member.

According to the tablet cassette of the present invention, pushing the cap downwards releases the engagement between the flexible portion and the flange and allows the rotor to be demounted from the securement member. Further, since the elastic force of the arm portion urges the rotor upwardly, the rotor can be demounted from the securement member without addition of force to the rotor. Thus, the rotor is easily demounted from the tablet cassette, thereby preventing falling of the powder from the bottom of the tablet cassette or adhesion of the powder to a human's hand.

### BRIEF DESCRIPTION OF THE DRAWINGS

FIG. 1 is a sectional view of a tablet cassette of the present invention.

FIG. 2 is an exploded perspective view of a partitioning unit according to a first embodiment of the present invention.

FIG. 3 is a perspective view showing that the partitioning unit shown in FIG. 2 is assembled, wherein it is viewed from outside in one direction.

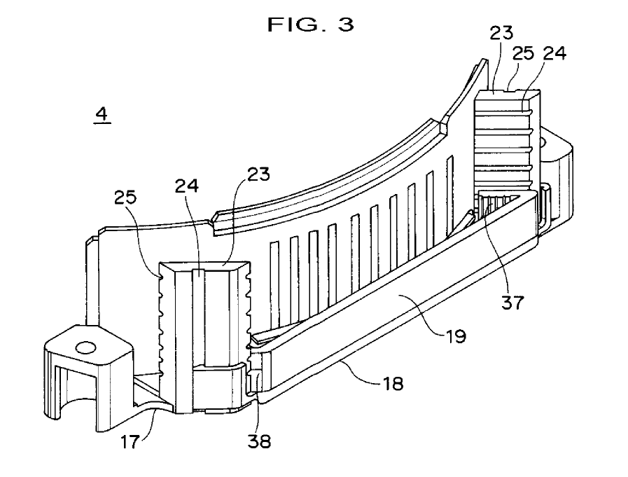

FIG. 4 is a perspective view showing that the partitioning unit shown in FIG. 2 is assembled, wherein it is viewed from outside in another direction.

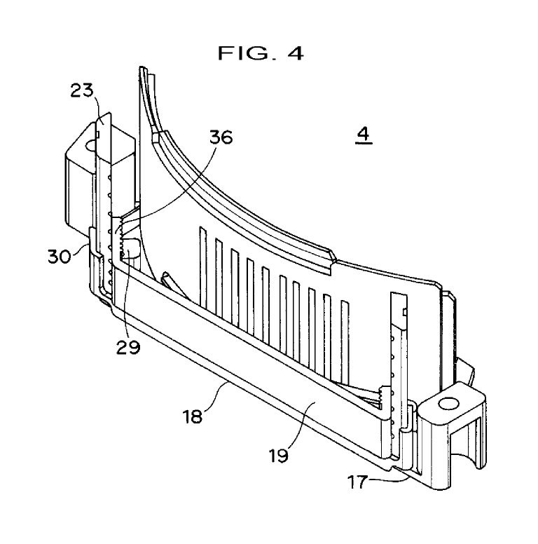

FIG. 5 is a perspective view showing that the partitioning unit shown in FIG. 2 is assembled, wherein it is viewed from inside.

FIG. 6 is a top view of the partitioning unit showing the operation of a partitioning member shown in FIG. 2.

FIG. 7 is an exploded perspective view of a partitioning unit according to a second embodiment of the present invention.

FIG. 8 is a perspective view showing that the partitioning unit shown in FIG. 7 is assembled, wherein it is viewed from outside in one direction.

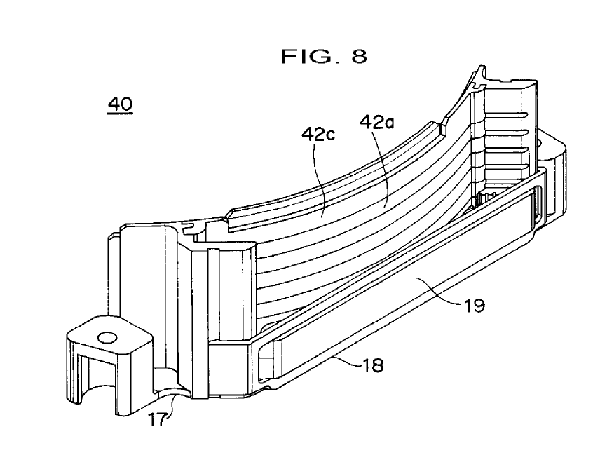

FIG. 9 is a perspective view showing that the partitioning unit shown in FIG. 7 is assembled, wherein it is viewed from inside.

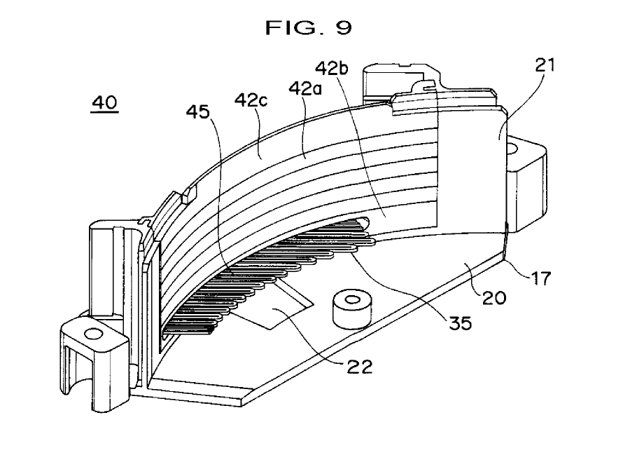

FIG. 10 is a front view of a partitioning unit according to a third embodiment of the present invention.

FIG. 11 is a top view of a closure piece shown in FIG. 10.

FIG. 12 is a top view of a partitioning member shown in FIG. 10.

FIG. 13 is an enlarged sectional view taken along the line XIII-XIII of FIG. 12.

FIG. 14 is a front view of a partitioning unit according to a fourth embodiment of the present invention.

FIG. 15 is a perspective view showing that the partitioning unit shown in FIG. 14 is assembled, wherein it is viewed from inside.

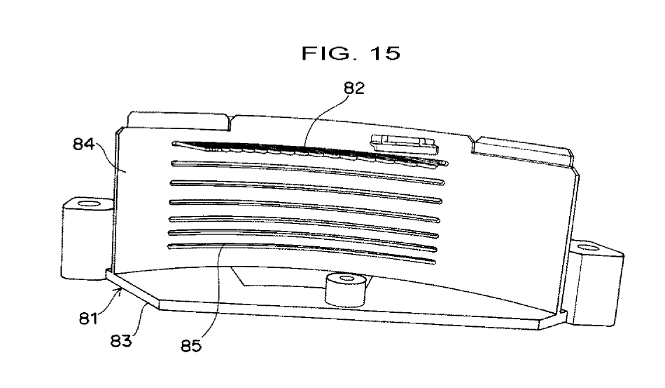

FIG. 16 is a sectional view showing that the partitioning unit shown in FIG. 14 is attached.

FIG. 17 is an exploded perspective view according to a fifth embodiment of the present invention.

FIG. 18 is a side view showing that a partitioning member, a retention member and an adjustment member shown in FIG. 17 are assembled together.

FIG. 19 is a perspective view of a closure member shown in FIG. 17.

FIG. 20A is an enlarged perspective view of the partitioning member shown in FIG. 17.

FIG. 20B is a perspective view wherein FIG. 20A is viewed in another direction.

FIG. 21A is an enlarged perspective view of the retention member shown in FIG. 17.

FIG. 21B is a perspective view wherein FIG. 21A is viewed in another direction.

FIG. 21C is a bottom view wherein FIG. 21A is viewed in another direction.

FIG. 22A is an enlarged perspective view of the adjustment member shown in FIG. 17.

FIG. 22B is a perspective view wherein FIG. 22A is viewed in another direction.

FIG. 22C is a bottom view wherein FIG. 22A is viewed in another direction.

FIG. 23 is a perspective view of a tablet cassette according to an embodiment of the present invention.

FIG. 24 is a perspective view of a rotor to be mounted in the tablet cassette shown in FIG. 23, wherein the rotor is viewed from above.

FIG. 25 is a perspective view the rotor shown in FIG. 24, wherein the rotor is viewed from below.

FIG. 26 is a front view of a cap that is attached to the rotor shown in FIG. 24.

FIG. 27 is a side view of the cap shown in FIG. 26.

FIG. 28 is a perspective view of a securement member that mounts the rotor shown in FIG. 24 to a drive shaft shown in FIG. 1.

FIG. 29 is a sectional view taken along the line A-A, showing that the cap is attached to the rotor and the rotor is fixed to the drive shaft through the securement member.

FIG. 30 is a sectional view showing that the cap shown in FIG. 29 is pushed downward and thus the engagement between the rotor and the securement member is released.

FIG. 31 is a sectional view showing that the engagement between the rotor and the securement member is released and thereafter the rotor and the cap are lifted from the tablet cassette by means of a holder.

FIG. 32 is a sectional view taken along the line B-B, showing that the cap is attached to the rotor and the rotor is fixed to the drive shaft through the securement member.

FIG. 33 is a top view of a rotor and a cap according to another embodiment.

FIG. 34 is a sectional view taken along the line C-C, showing a tablet cassette with the rotor and the cap shown in FIG. 33.

FIG. 35 is a top view of a rotor according yet another embodiment.

FIG. 36 is a sectional view showing that a prior art rotor is fixed to a drive shaft.

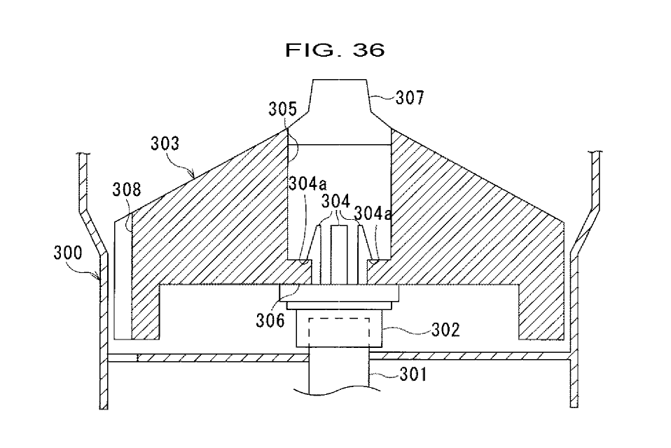

### DETAILED DESCRIPTION

Descriptions are made as to embodiments of the present invention with reference to the accompanying drawings.

### First Embodiment

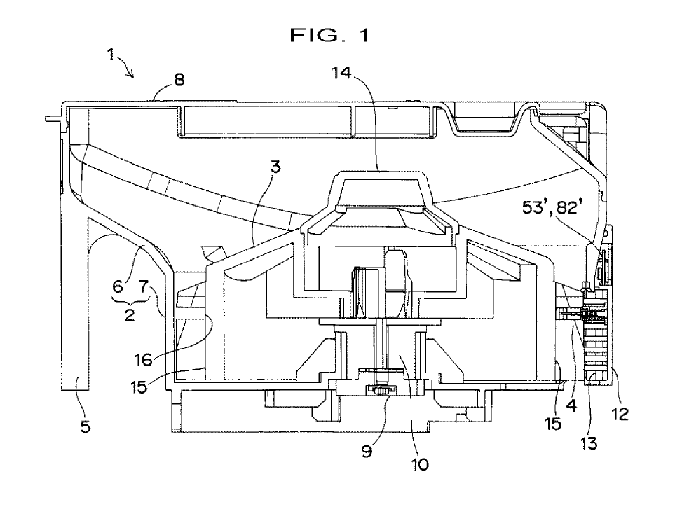

FIG. 1 is a sectional view of a tablet cassette 1 according to a first embodiment of the present invention. The tablet cassette 1 is a device that is mounted to a cassette mounting portion (motor base) of a tablet storing and dispensing apparatus (not shown) and dispenses a required number of contained tablets in accordance with a prescription data.

The tablet cassette 1 comprises a cassette body 2, a rotor 3 rotatably disposed on a bottom of an inside of the cassette body 2, and a partitioning unit 4 mounted to an outside of the cassette body 2.

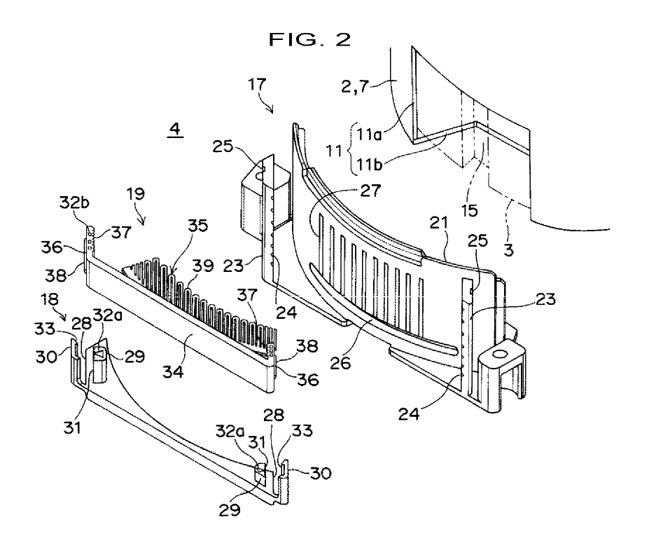

The cassette body 2 is a bottomed container that is upwardly open. The cassette body 2 has a handle 5 on its outer surface. An upper section of the cassette body 2 is a tablet receiving section 6, while a lower section thereof is a rotor housing section 7. The upper opening of the cassette body 2 is closed by a cover 8. The tablet receiving section 6 receives tablets on the rotor 3. A drive shaft 10 is provided in a bottom wall of the rotor housing section 7. The drive shaft 10 has a drive gear 9 that meshes with an output gear 7 of a motor provided in the cassette mounting portion of the tablet storing and dispensing apparatus. As shown in FIG. 2, an opening 11 is formed from a side wall of the rotor housing section 7 to the bottom wall thereof. An opening 11a located in the side wall faces toward an outer peripheral surface of the rotor 3, while an opening 11b located in the bottom wall faces toward a bottom surface of the rotor 3. To cover the opening 11a of the side wall of the rotor housing section 7, a lid member 12 is openably and closably attached to the cassette body 2 via a hinge.

The rotor 3 has a substantially cylindrical shape with an open lower end and a closed upper end. A top of the rotor 3 has a conical shape. The rotor 3 is disposed in the rotor housing section 7 of the cassette body 2. The rotor 3 is coupled to the drive shaft 10 and is rotatably driven by the drive shaft 10. Further, the rotor 3 can be demounted upwardly in an axial direction by loosening a mounting screw 14, which covers the drive shaft 10 and projects at an upper center of the rotor. The outer peripheral surface of the rotor 3 is formed with a plurality of guide grooves 15 extending in the axial direction. The guide grooves 15 are formed circumferentially equidistantly. Further, the outer peripheral surface of the rotor 3 is formed with a circumference groove 16 that extends in the circumferential direction across the guide grooves 15.

As shown in FIG. 2, the partitioning unit 4 comprises a closure member 17 covering the opening 11 of the cassette body 2, a retention member 18 attached to the closure member 17, and a partitioning member 19 attached to the retention member 18.

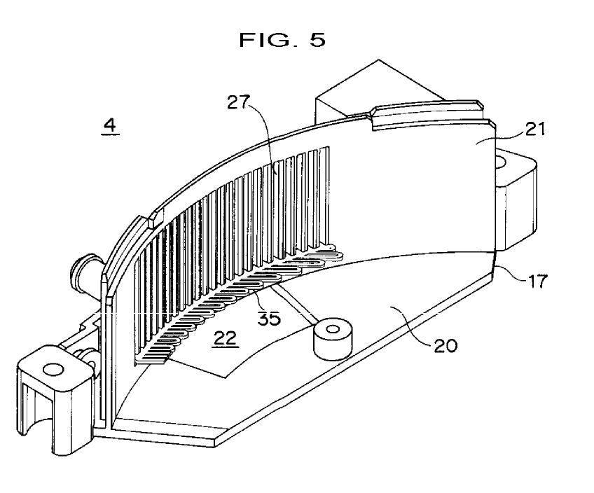

The closure member 17 has a base portion 20 and a vertical wall portion 21. The base portion 20 has a shape of a flat thin elongated plate and closes the opening 11b of the bottom wall of the cassette body 2. The vertical wall portion 21 is curved and stands from the base portion 20. The vertical wall portion 21 closes the opening 11a of the side wall of the cassette body 2. A tablet outlet 22, which communicates with the guide groove 15 of the rotor 3, is formed in the middle of the base portion 20 (see FIG. 5). A support portion 23 for attachment of the retention member 18 (this will be described below) is formed at either end of the base portion 20 as standing parallel to the vertical wall portion 21. A large number of horizontal grooves 24 are formed in a surface of the support portion 23, which faces toward the vertical wall portion 21, at a regular pitch. A vertical groove 25 is formed in a surface facing away from the vertical wall portion 21. A horizontal slit 26 is formed in the vicinity of the base portion 20 in the vertical wall portion 21. A plurality of vertical slits 27, which extend upward from an upper edge of the horizontal slit 26, are formed at a regular spacing along a circumferential direction. The horizontal slit 26 is sized such that a partitioning portion 35 of the partitioning member 19 can be inserted to the horizontal slit in its entirety. The vertical slit 27 is sized such that at least one of elastic bristles 39, which constitute the partitioning portion 35 of the partitioning member 19, can be inserted to the vertical slit.

The retention member 18 has a shape of a thin elongated plate having an edge having the same curvature as the vertical wall portion 21. A cutout 28, to which the support portion 23 of the closure member 17 can be inserted, is formed at either end of the retention member 18. A strut 29 and a projection tab 30, which are opposed to each other with the cutout 28 therebetween, are formed as standing from the top of the retention member 18. A surface of the strut 29, which faces toward the projection tab 30, is formed with a large number of engaged grooves 31 at a regular spacing. The engaged grooves 31 extend in the axial direction of the rotor 3. A triangular matchmark 32a is marked on the top of the strut 29. A claw 33, which engages the vertical groove 25 of the support portion 23 of the closure member 17, is formed at a tip end of the projection tab 30.

The partitioning member 19 has a base portion 34, which has a shape of a thin elongated plate, and a partitioning portion 35. The base portion 34 has a surface perpendicular to the top surface of the retention member 18. The partitioning portion 35 extends from the surface of the base portion 34. Both ends of the base portion 34 are bent to thus form an attaching portion 36. Engaging ridges 37, which engage the engaged grooves 31 of the strut 29 of the retention member 18, are formed in one surface of the attaching portion 36 (facing toward the partitioning portion 35) at a regular spacing. A horizontal ridge 38, which engages the horizontal groove 24 of the support portion 23 of the closure member 17, is formed in the opposite surface of the attaching portion 36 (facing away from the partitioning portion 35). The partitioning portion 35 takes the form that a plurality of elastic bristles 39, which obliquely project from the base portion 34, are arranged side by side. Tip ends of adjacent elastic bristles, except for elastic bristles located at ends, are joined to each other in a U shape. The partitioning portion 35 of the partitioning member 19 projects from the horizontal slit 26 of the closure member 17 toward the inside of the cassette body 2 and then enters the circumference groove 16 of the rotor 3. Further, the partitioning portion 35 enters the guide groove 15 when the guide groove 15 comes to a position where it is in communication with the tablet outlet 22.

When assembling the partitioning unit 4, the closure member 17 is screw-coupled to the cassette body 2 first, thus closing the opening 11 of the cassette body 2. Next, the attaching portion 36 of the partitioning member 19 is inserted in between the strut 29 and the projection tab 30 of the retention member 18, and the engaging ridges 37 of the attaching portion 36 and the engaged grooves 31 of the strut 29 of the retention member 18 are brought into engagement with each other, thereby having the retention member 18 retain the partitioning member 19. The support portion 23 of the closure member 17 is inserted in between the attaching portion 36 of the partitioning member 19 and the projection tab 30 of the retention member 18 retaining the partitioning member 19, and the engaging ridges 38 of the attaching portion 36 of the partitioning member 19 and the horizontal grooves 24 of the closure member 17 are brought into engagement with each other, thereby attaching the retention member 18, which retains the partitioning member 19, to the closure member 17.

Next, descriptions are made as to the operation of the tablet cassette 1 having the above-described configuration.

The tablet cassette 1 (wherein the tablet receiving section 6 of the cassette body 2 receives tablets) is mounted on the cassette mounting portion of the tablet storing and dispensing apparatus and a motor of the cassette mounting portion is driven under a direction of a control unit of the tablet storing and dispensing apparatus. Then, the rotor 3 of the tablet cassette 1 is rotated and thus the tablets in the tablet receiving section 6 enter the guide groove 15 of the rotor 3. If the guide groove 15 approaches the tablet outlet 22 by the rotation of the rotor 3, then the partitioning portion 35 of the partitioning member 19 enters the guide groove 15 and divides the lower tablet from another tablet located thereabove. Only the lower tablet is dispensed from the tablet outlet 22. As the rotor 3 continues its rotation, the tablets are discharged from each guide groove 15 in sequence. If a required number of tablets are discharged, then the rotor 3 is stopped.

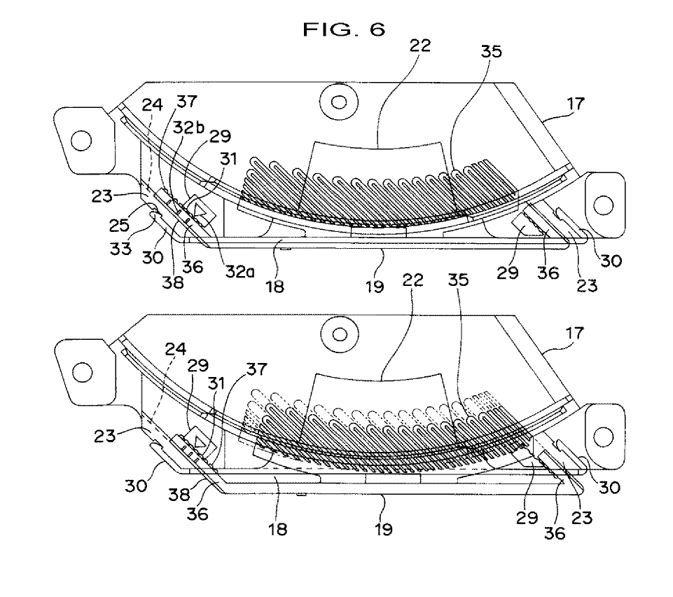

When changing the tablets in the tablet cassette 1 with other types of tablets and storing the same, the mounting screw 14 of the rotor 3 is unfastened and the rotor 3 is demounted and then replaced with a rotor 3 having a guide groove 15 that has width and depth corresponding to the size of a tablet. Next, the task of setting the partitioning portion 35 of the partitioning member 19 to a position and an entrance depth corresponding to the size of the tablet is performed. With respect to the task, first, the retention member 18 is moved upwardly or downwardly relative to the closure member 17 such that the partitioning portion 35 is positioned between the lower tablet and another tablet located thereabove. Further, the ridge 38 of the attaching portion 36 of the partitioning member 19 and the horizontal groove 24 of the closure member 17 are brought into engagement with each other in a suitable position. Thereafter, as shown in FIG. 6, the partitioning member 19 is horizontally moved relative to the retention member 18, thereby bringing the engaging ridge 37 of the attaching portion 36 and the engaged groove 31 of the strut 29 of the retention member 18 into engagement with each other in a suitable position. Thus, the partitioning portion 35 of the partitioning member 19 is moved in a radial direction of the rotor 3 from a position shown by a solid line in FIG. 6 to a position shown by a dashed line in FIG. 6, thereby adjusting the partitioning member 35 relative to the guide groove 15 of the rotor 3 in a suitable position. In this case, matchmarks 32b, which match to the matchmark 32a of the retention member 18, may be provided in the partitioning member 19 in a plurality of positions in advance.

In the first embodiment, the closure member 17 closes the opening 11 of the cassette body 2 and the horizontal slit 19, which the partitioning member 19 enters, and the vertical slits 27, which the elastic bristle 39 enter, are formed in the closure member 17. Alternatively, the opening 11 and the closure member 17 may be omitted and a slit shaped similarly to the horizontal slit 26 and the vertical slits 27 may be directly formed in the cassette body 2. In the embodiments to be described below, each part included in the closure member may be directly formed in the cassette body 2.

### Second Embodiment

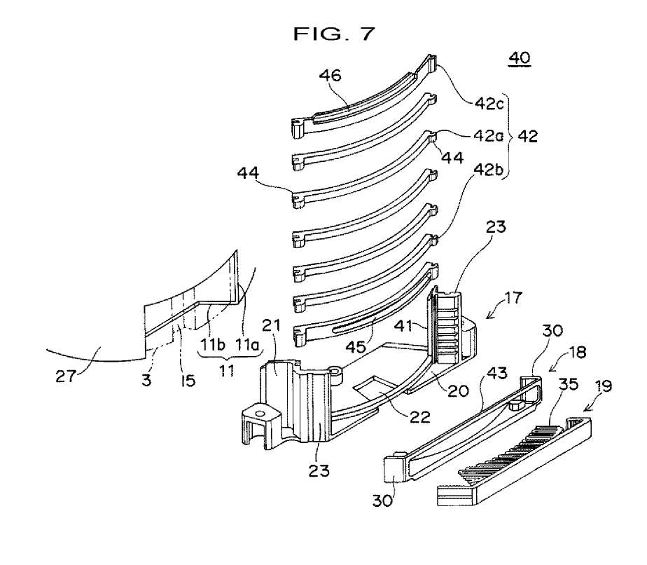

FIG. 7 is an exploded perspective view of a partitioning unit 40 attached to the tablet cassette according to a second embodiment of the present invention. Further, the cross-section of the tablet cassette 1 in second to fourth embodiments to be described below is basically the same as the cross-section of the tablet cassette 1 shown in FIG. 1. Thus, it is described with reference to FIG. 1.

The partitioning unit 40 is similar to the partitioning unit 4 of the first embodiment unless it is described otherwise. Thus, like reference numerals are denoted to corresponding elements or components. Similar to the first embodiment, the partitioning unit 40 comprises a closure member 17, a retention member 18 and a partitioning member 19. The closure member 17 has the same configuration as that of the first embodiment except that the support portion 23 is connected to the vertical wall 21 for purposes of reinforcement, that the vertical wall 21 is formed with a cutout 41 which is U-shaped when viewed from the front and faces toward the opening 11a located in the side wall of the cassette body 2, and that a plurality of closure pieces 42 are attached to the cutouts 41. The retention member 18 has the same configuration as that of the first embodiment except that a connection portion 43 interconnecting the upper ends of two projection tabs 30 is provided for purposes of reinforcement. The partitioning member 19 has the same configuration as the partitioning member of the first embodiment.

The closure piece 42 includes seven pieces in total in three types, which comprise first closure pieces 41a (five), a second closure piece 42b (one) and a third closure piece 42c (one). All of them are divided in the axial direction of the rotor 3 and are bent at the same curvature as the vertical wall portion 21. The first closure piece 42a has, at either end thereof, a U-shaped engaging portion 44, which engages the both lateral edges of the cutout 41 and is slidable in the axial direction of the rotor 3. The second closure piece 42b has the same shape as the first closure piece 42a except that it has a slit 45 extending in the circumferential direction of the rotor 3. The third closure piece 42c has the same shape as the first closure piece 42a except that a thin insertion portion 46 protrudes upwardly in the middle of an upper edge of the third closure piece and the insertion portion 46 is inserted to a groove (not shown) provided in an upper edge of the opening 11a of the cassette body 2. The third closure piece 42c is attached to the cutout in the uppermost position. The first closure piece 42a and the second closure piece 42b are attached below the third closure piece 42c. The second closure piece 42b can be replaced with any one of the first closure pieces 42a. Thus, the vertical position of the slit 45 may be changed.

In the tablet cassette 1 having the above-described configuration, the task of setting the partitioning portion 35 of the partitioning member 19 to the position and entrance depth corresponding to the size of a tablet is performed in the same manner as the first embodiment. The rotor 3 is replaced and then the second closure piece 42b is replaced with any one of the first closure pieces 42a such that the slit 45 of the second closure piece 42b is positioned between the lower tablet and another tablet located thereabove. Next, the retention member 18 is moved upwardly or downwardly and positioned at the same position as the slit 45 of the second closure piece 42b. Then, the partitioning member 19 is mounted to the retention member 18 and the partitioning portion 35 is inserted to the slit 45 of the second closure piece 42b. At this time, the partitioning member 19 is horizontally moved relative to the retention member 18 such that the tip end of the partitioning portion 35 is at a suitable entrance depth in the guide groove 15 of the rotor 3.

### Third Embodiment

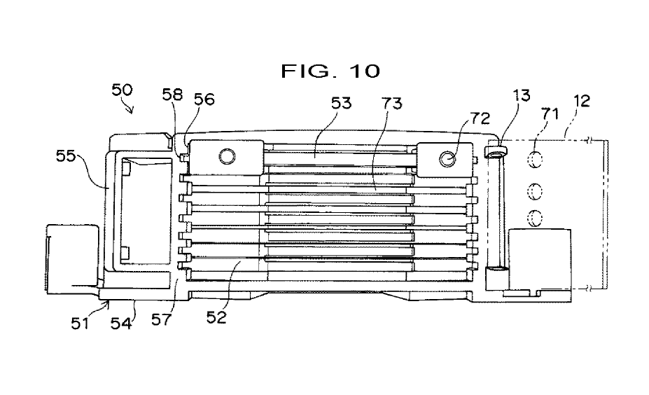

FIG. 10 is a front view of a partitioning unit 50 that is attached to the tablet cassette 1 according to a third embodiment of the present invention.

The partitioning unit 50 comprises: a closure member 51 covering the opening 11 of the cassette body 2; a plurality of closure pieces 52 attached to the closure member 51; and a partitioning member 53 attached to the closure member 51 together with the closure piece 52.

The closure member 51 has a base portion 54, which has a shape of a thin flat elongated plate and closes the opening 11b located in the bottom wall of the cassette body 2, and a vertical wall portion 55, which stands from the base portion 54 and is bent alongside the side wall of the cassette body 2. The vertical wall portion 55 of the closure member 51 is formed with a rectangular opening 56 that faces toward the opening 11a of the side wall of the cassette body 2. A rectangular frame portion 57 protrudes in a radially outward direction of the rotor 3 along a peripheral edge of the opening 56 of the vertical wall portion 55. Opposing left and right inner surfaces of the frame portion 57 are formed with a plurality of grooves 58, which extend in the radial direction of the rotor 3, along the axial direction of the rotor 3. Further, a hinge 13, which supports the lid member 12 covering the entire frame portion 57, is provided in the vertical wall portion 55.

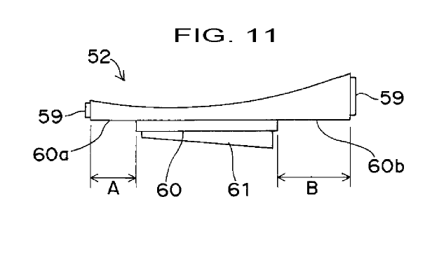

As shown in FIG. 11, the closure piece 52 has a shape of a thin elongated plate. An engaging projection 59, which engages the groove 58 of the frame portion 57 of the closure member 51, is formed at either end of the closure piece 52. An inner side of the closure piece 52, which faces toward the rotor 3, is formed in an arc shape alongside the outer peripheral surface of the rotor 3. A knob portion 60 protrudes on an outer side of the closure piece 52. To prevent erroneous mounting of the partitioning member 53 in a right and left reversed manner, a distance A of a first shoulder portion 60a, which ranges from a left end of the closure piece 52 to a left end of the knob portion 60, is different from a distance B of a second shoulder portion 60b, which ranges from a right end of the closure piece 52 to a right end of the knob portion 60. This will be described in detail below. Further, a protrusion 61 is formed in the knob portion 60. To prevent erroneous mounting of the closure piece 52 in a right and left reversed manner, the protrusion 61 has a slope from left to right. This will also be described in detail below.

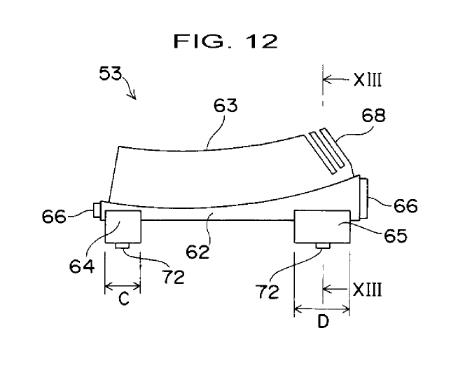

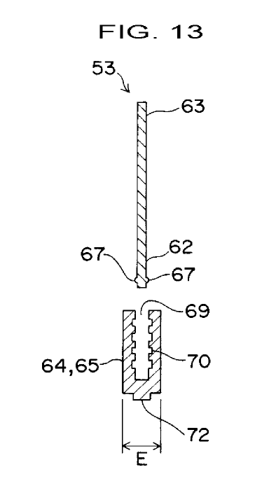

As shown in FIG. 12, the partitioning member 53 comprises a base portion 62 having the same shape as the closure piece 52, a partitioning portion 63, a first projecting portion 64 and a second projecting portion 65. The base portion 62 has a shape of a thin elongated plate. An engaging projection 66, which engages the groove 58 of the frame portion 57 of the closure member 51, is formed at either end. An inner side of the base portion 62, which faces toward the rotor 3, is formed in an arc shape alongside the outer peripheral surface of the rotor 3. As shown in FIG. 13, a ridge 67, which extends in a direction perpendicular to an insertion direction of the partitioning member 53 (right and left directions), is formed on upper and lower surfaces of the base portion 62. Similar to the partitioning portion 35 of the partitioning member 19 in the first embodiment, the partitioning portion 63 comprises elastic bristles 68. As shown in FIG. 13, the first and second projecting portions 64, 65 are formed in a U-shaped cross-section by forming a groove 69 therein. Opposing surfaces of the groove 69 are formed with a plurality of engaging grooves 70, which the ridge 67 of the base portion 62 engages, along the insertion direction of the partitioning member 53. By bringing the ridge 67 of the base portion 62 and one of the plurality of the engaging grooves 70 into engagement with each other, both end sides of the base portion 62 are inserted to the first and second projecting portions 64, 65 and the first and second protrusions 64, 65 are attached to the both end sides. As shown in FIG. 12, a distance C of the first projecting portion 64 in right and left directions is substantially the same as the distance A of the first shoulder portion 60a of the closure piece 52, while a distance D of the second projecting portion 65 in right and left directions is substantially the same as the distance B of second shoulder portion 60b of the closure piece 52. Further, a thickness E of the first and second projecting portions 64, 65 is sized such that the projecting portions partially overlap with the closure piece 52, which is adjacent thereto when viewed from the front, when the partitioning member 53 is mounted. To prevent rattling of the partitioning member 53, a projection 72 is formed in back surfaces of the first and second projecting portions 64, 65. The projection 72 engages a recess 71 formed on the inner surface of the lid member 62 when the lid member 12 is closed.

In the tablet cassette 1 including the partitioning unit 50 having the above-described configuration, the task of setting the partitioning portion 63 of the partitioning member 53 to the position and entrance depth corresponding to the size of the tablet is performed in the same manner as the first embodiment. The rotor 3 is replaced and then the partitioning member 53 is replaced with any one of the closure pieces 52 such that the partitioning portion 63 is positioned between the lower tablet and another tablet located thereabove. In this case, the plurality of the engaging grooves 70 of the first and second projecting portions 64, 65, which the ridges 67 of the base portion 62 engage, are selected such that a tip end of the partitioning portion 63 may be located at a suitable entrance depth in the guide groove 15 of the rotor 3.

In the third embodiment, the partitioning member 53 is mounted in a position offset from a center line of the cassette body 2. Thus, it cannot be formed symmetrically right and left. For this reason, if the closure piece 52 is mounted in a right and left reversed manner, then it interferes with the rotor 3. Further, if the partitioning member 53 is mounted in a right and left reversed manner, then the function of the partitioning member is impaired. Thus, the third embodiment employs a structure for preventing erroneous mounting of the closure piece 52 and the partitioning member 53 in a right and left reversed manner. In the state shown in FIG. 11, the protrusion 61 of the closure piece 52 does not interfere with the inner surface of the lid member 12. However, if the closure piece 52 is mounted in a right and left reversed manner, then the protrusion 61 would interfere with the inner surface of the lid member 12 and thus the lid member 12 cannot be closed. Accordingly, the closure piece 52 must be inevitably mounted in a normal state. Further, in the state shown in FIG. 12, the first and second projecting portions 64, 65 of the partitioning member 53 do not interfere with the knob portion 60 of the closure piece 52 adjacent thereto. However, if the partitioning member 53 is mounted in a right and left reversed manner, then the first and second projecting portions would interfere with the knob portion 60 of the adjacent closure piece 52. Accordingly, the partitioning member 53 must be inevitably mounted in a normal state.

Further, if the partitioning portion 63 of the partitioning member 53 is not accurately positioned between the lower tablet and another tablet located thereabove, the lower tablet may not fall, or both the lower tablet and another tablet located thereabove may be discharged simultaneously. Thus, the third embodiment employs a structure for preventing rattling of the partitioning member 53. That is, as shown in FIG. 10, if the closure piece 52 and the partitioning member 53 are mounted and thereafter the lid member 12 is closed, the projection 72 of the partitioning member 53 engages the recess 71 of the lid member 12, thus fixing the position of the partitioning member 53 and thereby eliminating said rattling. Thus, the tablets can be reliably dispensed one at a time. Alternatively, the projection 72 of the partitioning member 53 and the recess 71 of the lid member 12 may be arranged vice versa.

Further, in the third embodiment, if a gap between adjacent closure pieces 52 is large, then foreign substance such as dust may enter. Thus, to close the gap, a strip portion 73 may be left in advance when forming the opening 56 in the vertical wall portion 55.

### Fourth Embodiment

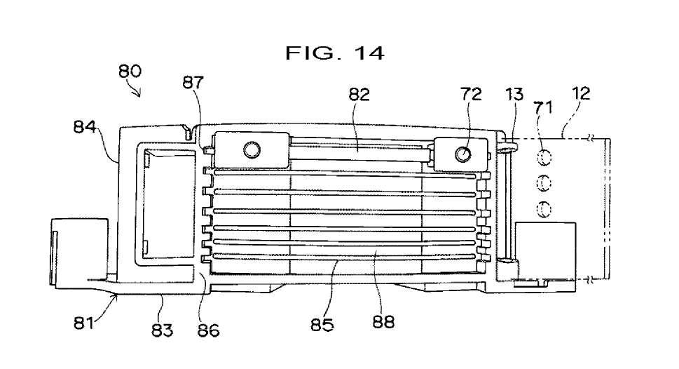

FIG. 14 is a front view of a partitioning unit 80 that is attached to the tablet cassette 1 according to a fourth embodiment of the present invention.

The partitioning unit 80 comprises a closure member 81 covering the opening 11 of the cassette body 2, and a partitioning member 82 attached to the closure member 81.

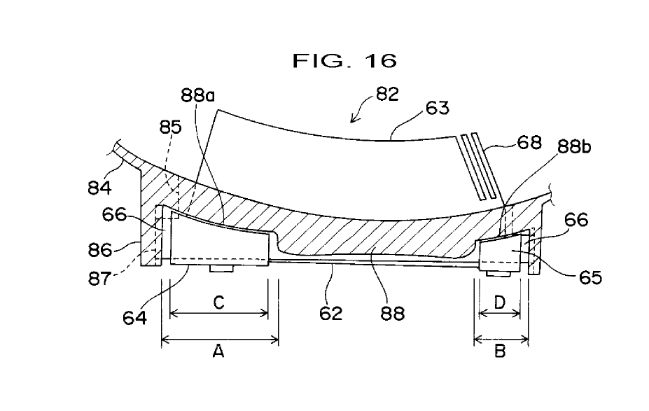

The closure member 81 has a base portion 83, which has a shape of a thin flat elongated plate and closes the opening 11b of the bottom wall of the cassette body 2, and a vertical wall portion 84, which stands from the base portion 83 and is curved alongside the side wall of the cassette body 2. The vertical wall portion 84 of the closure member 81 is formed with a plurality of slits 85, which face toward the opening 11a of the side wall of the cassette body 2 and extend in the circumferential direction of the rotor 3, along the axial direction of the rotor 3. A rectangular frame portion 86 protrudes in the radially outward direction of the rotor 3 to encircle all the slits 85. Opposing inner surfaces of right and left sides of the frame portion 86 are formed with a plurality of grooves 87, which extend in the radial direction of the rotor 3, along the axial direction of the rotor 3. A protrusion 88 is formed in the middle of the vertical wall portion 84 inside the frame portion 86. As shown in FIG. 16, to prevent erroneous mounting of the partitioning member 82 in a right and left reversed manner, a distance A of a first shoulder portion 88a, which ranges from the inner surface of the left wall of the frame portion 86 to a left end of the protrusion 88, is different from a distance B of a second shoulder portion 88b, which ranges from the inner surface of the right wall of the frame portion 86 to a right end of the protrusion 88. This will be described in detail below. Further, a hinge 13, which supports the lid member 12 covering the entire frame portion 86, is provided in the vertical wall portion 84.

The partitioning member 82 has the same configuration as the partitioning member of the third embodiment. Referring again to FIGS. 12, 13 and 16, the partitioning member 82 includes the base portion 62, the partitioning portion 63, the first projecting portion 64 and the second projecting portion 65. The base portion 62 has a shape of a thin elongated plate. The engaging projection 66, which engages the groove 87 of the frame portion 86 of the closure member 51, is formed at either end of the base portion 62. The inner side of the base portion 62, which faces toward the rotor 3, is formed in an arc shape alongside the outer peripheral surface of the rotor 3. The ridge 67, which extends in a direction perpendicular to the insertion direction of the partitioning member 82 shown in FIG. 13 (right and left directions), is formed in the upper surface and the lower surface of the base portion 62. Similar to the partitioning member 19 in the first embodiment, the partitioning portion 63 comprises elastic bristles 68. As shown in FIG. 13, the first and second projection portions 64, 65 are formed in a U-shaped cross-section by forming the groove 69 therein. Opposing surfaces of the groove 69 are formed with a plurality of engaging grooves 70, which the ridge 67 of the base portion 62 engage, along the insertion direction of the partitioning member 82. By bringing the ridge 67 of the base portion 62 and one of the plurality of the engaging grooves 70 into engagement with each other, both end sides of the base portion 62 are inserted to the first and second projection portions 64, 65 and the first and second projection portions 64, 65 are attached to the both end sides. As shown in FIG. 16, a distance C of the first projecting portion 64 is substantially the same as a distance A of a first shoulder portion 88a located between the left side of the frame portion 86 and the protrusion 88, while a distance D of the second projecting portion 65 is substantially the same as a distance B of second shoulder portion 88b located between the right side of the frame portion 86 and the protrusion 88. To prevent rattling of the partitioning member 82, the projection 72 is formed in the back surfaces of the first and second protrusions 64, 65. The projection 72 engages the recess 71 formed in the inner surface of the lid member 12 when the lid member 12 is closed.

In the tablet cassette 1 including the partitioning unit 80 having the above-described configuration, the task of setting the partitioning portion 63 of the partitioning member 82 to the position and entrance depth corresponding to the size of the tablet is performed in the same manner as the first embodiment. The rotor 3 is replaced and then the partitioning member 82 is inserted to any one of the plurality of the slits 85 of the vertical wall portion 84 such that the partitioning portion 63 is positioned between the lower tablet and another tablet located thereabove. In this case, the engaging grooves 70 of the first and second projection portions 64, 65, which the ridges 67 of the base portion 62 engage, are selected such that the tip end of the partitioning portion 63 is located at a suitable entrance depth in the guide groove 15 of the rotor 3.

The fourth embodiment also employs the structure for preventing the erroneous mounting of the partitioning member 82 in a right and left reversed manner. In the state shown in FIG. 16, the first and second projection portions 64, 65 of the partitioning member 82 do not interfere with the protrusion 88 of the vertical wall portion 84. However, if the partitioning member is mounted in a right and left reversed manner, the first and second projection portions would interfere with the protrusion 88. Accordingly, the partitioning member must be inevitably mounted in a normal state.

Further, similar to the third embodiment, the fourth embodiment also employs the structure for preventing rattling of the partitioning member 83. That is, as shown in FIG. 14, when the partitioning member 82 are mounted and thereafter the lid member 12 is closed, the projection 72 of the partitioning member 82 engages the recess 71 of the lid member 12, thus fixing the position of the partitioning member 82 and thereby eliminating said rattling. Thus, the tablets can be reliably dispensed one at a time. Alternatively, the projection 72 of the partitioning member 82 and the recess 71 of the lid member 12 may be arranged vice versa.

In the third and fourth embodiments, a pocket, which receives partitioning members 53′, 82′ having a different length of the partitioning portion 63 as shown in FIG. 1, may be provided inside the lid member 12 and the partitioning member may be replaced with these partitioning members.

### Fifth Embodiment

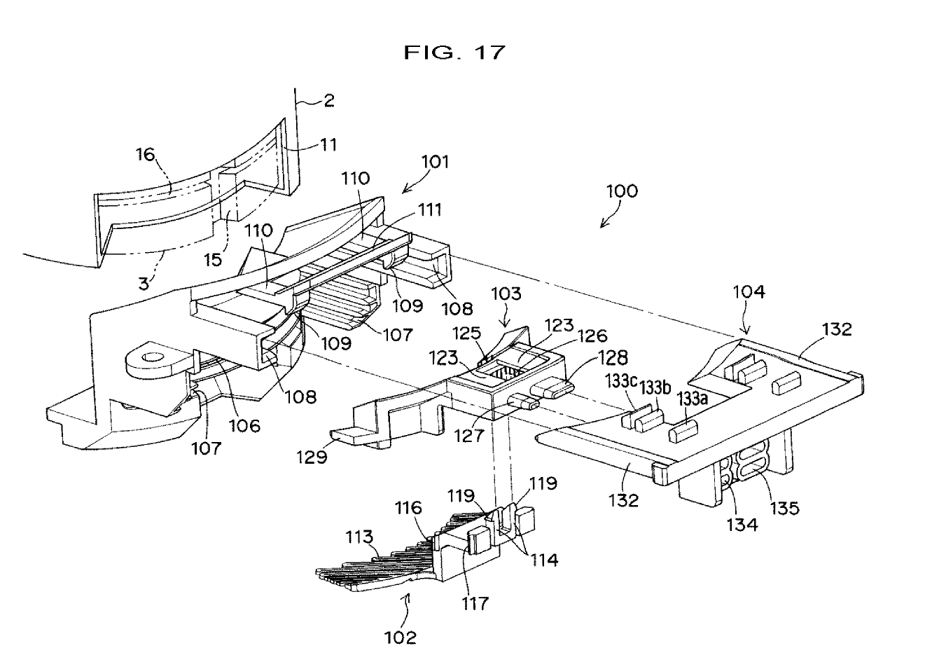

FIG. 17 is an exploded perspective view of a partitioning unit 100 that is attached to the tablet cassette according to a fifth embodiment of the present invention.

The partitioning unit 100 comprises a closure member 101, a partitioning member 102, a retention member 103 and an adjustment member 104.

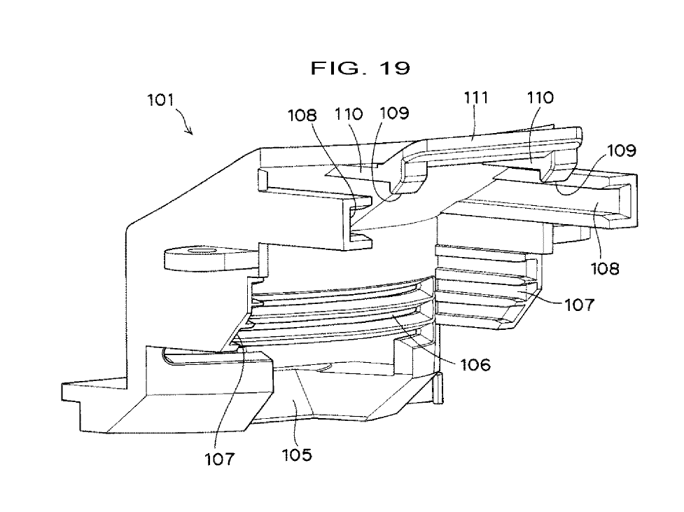

The closure member 101 is integrally attached to the cassette body 2 and constitutes a portion of the bottom wall and a portion of the side wall of the cassette body 2. As shown in FIG. 19, an opening 105 is formed in the closure member 101 through a side wall and a bottom wall of the closure member 101. Further, the closure member 101 is formed with a plurality of slits 106 (in this embodiment, three slits), which extend in the circumferential direction of the rotor 3, along the axial direction of the rotor 3. A partitioning portion 113 of the partitioning member 102 (this will be described below) is inserted to the slit 106. As many pairs of support grooves 107 as the slits 106 are formed in the vicinity of both ends of the slit 106. The support grooves 107 extend in a direction perpendicular to the axial direction of the rotor 3. A pair of guide grooves 108 extending in a direction perpendicular to the axial direction of the rotor 3 are formed above the support grooves 107. A pair of elastic pieces 110, each of which has an engaging claw 109 on an underside of a tip end, is provided above the pair of the guide grooves 108. A pressing portion 111 interconnects top sides of the tip ends of the pair of elastic pieces 110.

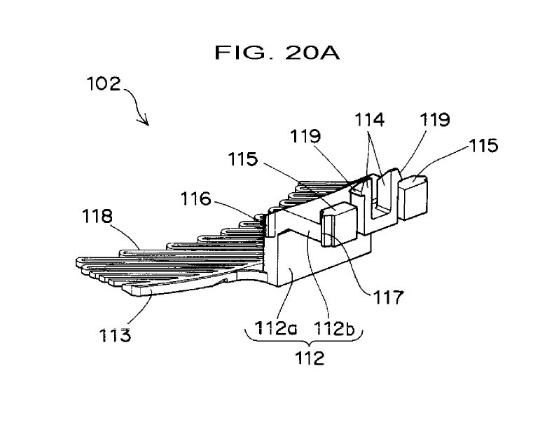

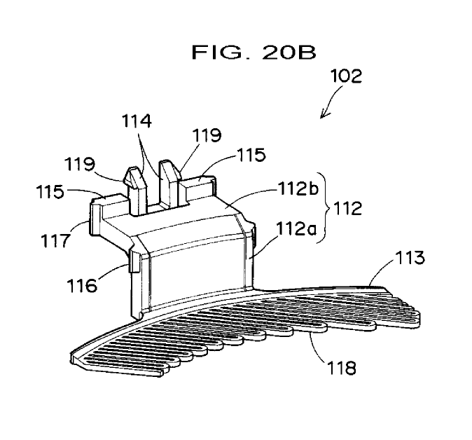

As shown in FIGS. 20A and 20B, the partitioning member 102 comprises a base portion 112, a partitioning portion 113 and a pair of elastic projections 114. The base portion 112 has a vertical section 112a and a horizontal section 112b, thus forming an L-shape. The base portion 112 has a pair of projection portions 115 that stand upward from both lateral sides of an end of the horizontal section 112b. A pair of first engaging portions 116, which extend in the axial direction of the rotor 3, are formed in both lateral ends of the vertical section 112a of the base portion 112. A pair of second engaging portions 117, which extend in the axial direction of the rotor 3, are formed in both lateral portions of the tip end of the horizontal section 112b as well as lateral ends of the projection portions 115. The first engaging portion 116 and the second engaging portion 117 comprise a projection having a triangular cross-section. A partitioning portion 113 is horizontally attached to a lower end of the vertical section 112a of the base portion 112. Similar to the partitioning portion 35 of the partitioning member 19 in the first embodiment, the partitioning portion 113 includes elastic bristles 118. The pair of the elastic projections 114 projects upwardly between a pair of the projection portions 115 of the base portion 112. An outwardly-projecting engaging claw 119 is formed at a tip end of the elastic projection 114.

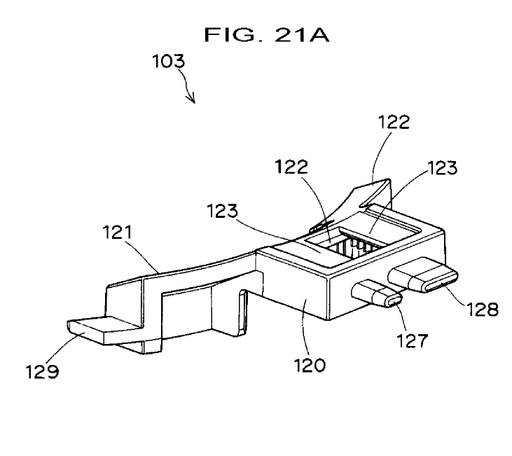

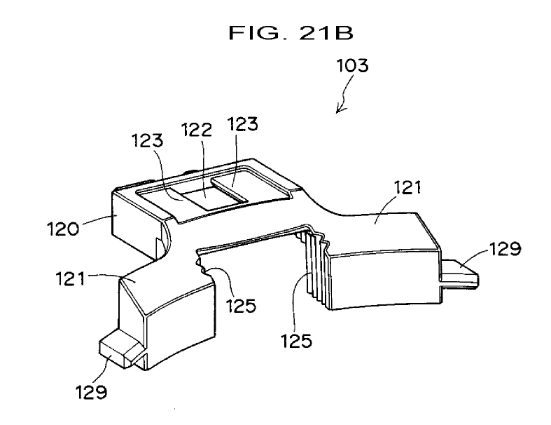

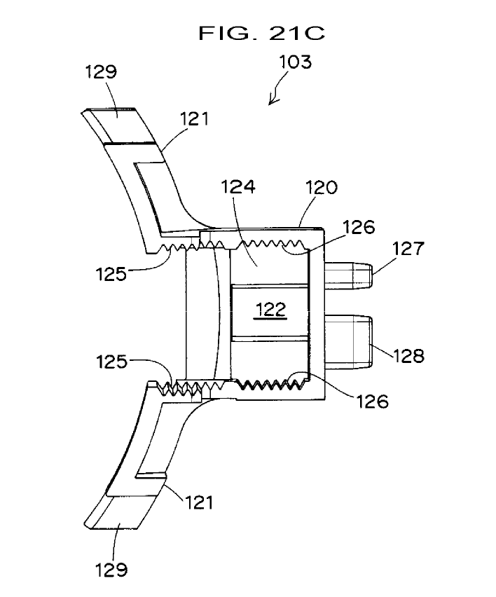

As shown in FIGS. 21A, 21B and 21C, the retention member 103 comprises a rectangular base portion 120 and a pair of wing portions 121. A rectangular aperture 122 is formed in the middle of the base portion 120 as piercing from a top side to a back side. Each of the opposing edges of the aperture 122 comprises an engaged portion 123, which the engaging claw 119 of the partitioning member 102 engages. A concave portion 124, which receives the horizontal section 112b of the base portion 112 of the partitioning member 102, is formed in the backside of the base portion 120 (see FIG. 21C). Opposing surfaces of the concave portion 124 are formed with a plurality of second engaged portions 126, which the second engaging portions 117 of the partitioning member 112 engages, along a direction perpendicular to the axial direction of the rotor 3. A first projection portion 127 and a second projection portion 128, which have a shape different from each other, project from an end face that faces away from the rotor 3 and is opposite to a face of the base portion 120 facing toward the rotor 3. The first projection portion 127 and the second projection portion 128 have an oval cross-section, wherein a thickness is equal and a width is different. A pair of the wing portions 121 extends obliquely in opposite directions from both ends of the end face of the rotor 3, which faces away from the rotor 3 and is opposite to the face facing toward the rotor 3. Proximal opposing surfaces of the pair of the wing portions 121 are formed with a plurality of first engaged portions 125, which the pair of the first engaging portions 116 of the partitioning member 102 engages respectively, along the direction perpendicular to the axial direction of the rotor 3. The first engaged portion 125 and the second engaged portion 126 comprise a series of parallel grooves that have a triangular cross section and extend in the axial direction of the rotor 3. A pair of projection tabs 129, which slidably engage the support groove 107 of the closure member 101, are provided in tip ends of the pair of wing portions 121.

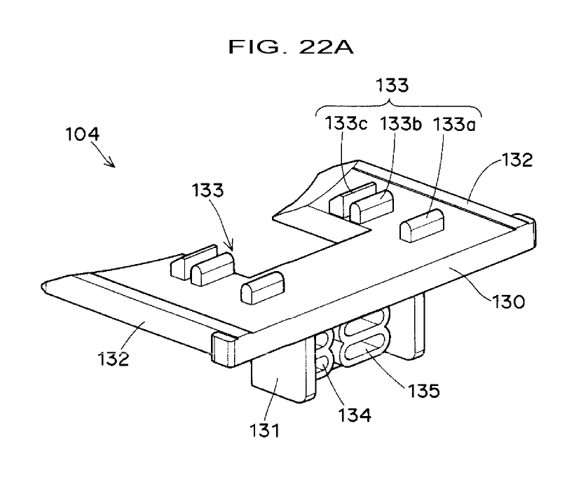

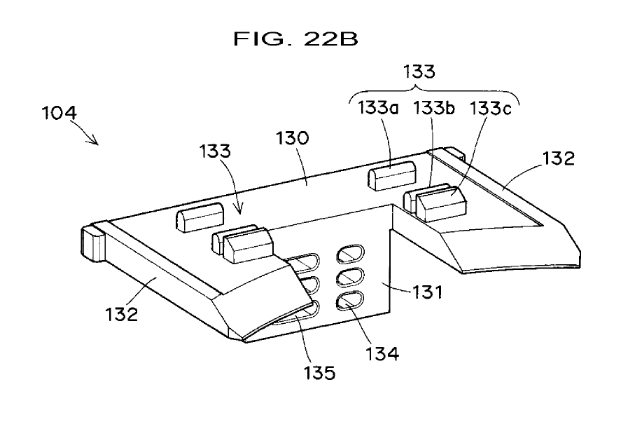

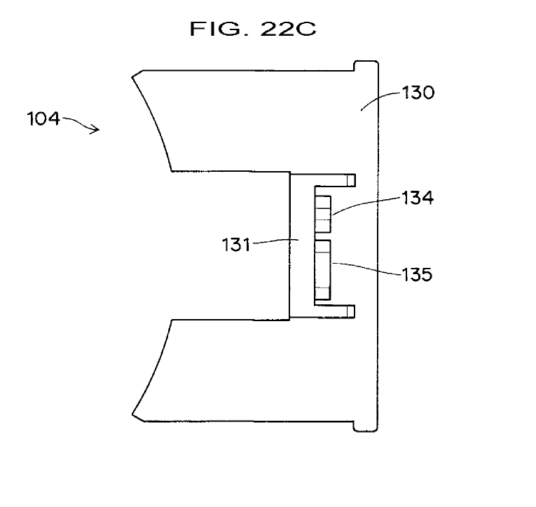

As shown in FIGS. 22A, 22B and 22C, the adjustment member 104 comprises a horizontal base portion 130, which is substantially U-shaped when viewed from above, and a vertical portion 131 downwardly extending from a backside of the base portion 130. A pair of guide grooves 132, which slidably engage the pair of the guide grooves 108 of the closure member 101, are provided in both lateral ends of the base portion 130. An upper surface of the base portion 130 is formed with an engaging portion 133, which the engaging claw 109 of the elastic piece 110 engages when the adjustment member 104 is in an advance position and in a retreat position. The engaging portion 133 includes a first engaging projection portion 133a, a second engaging projection portion 133b and a stopper 133c, which are located in such an order toward the rotor 3. The vertical portion 131 is formed with a plurality of first mounting holes 134 and a plurality of second mounting holes 135, which the first projection portion 127 and the second projection portion 128 of the retention member 103 engage respectively, along the axial direction of the rotor 3. Thus, only when the retention member 103 is in a predetermined orientation, the first projection portion 127 and the second projection portion 128 may engage the first mounting hole 134 and the second mounting hole 135, respectively.

In the tablet cassette 1 including the partitioning unit 100 having the above-described configuration, as shown in FIG. 17, the task of setting the partitioning portion 113 of the partitioning member 102 to the position and entrance depth corresponding to the size of the tablet is performed as follows. First, one of the first engaged portions 125 and one of the second engaged portions 126 are selected such that the partitioning portion 113 is positioned at the entrance depth corresponding to the size of the tablet (i.e., the depth of the guide groove 15 of the rotor 3). The partitioning member 102 is pushed to the retention member 103 while bringing the first engaging portion 116 and the second engaging portion 117 of the partitioning member 102 into engagement with the selected respective engaged portions. Thus, the engaging claw 119 of the elastic projection 114 of the partitioning member 102 engages the engaged portion 123 of the base portion 120 of the retention member 103, thereby having the retention member 103 retain the partitioning member 102.

Subsequently, the retention member 103, which retains the partitioning member 102 as described above, is attached to the adjustment member 104. At this time, one of the first mounting holes 134 and one of the second mounting holes 135 are selected such that the height of the partitioning portion 113 of the partitioning member 102 coincides with the circumference groove 16 of the rotor 3. The retention member 103 is pushed to the adjustment member 104 while bringing the first projection portion 127 and the second projection portion 128 of the retention member 103 into engagement with the selected respective first and second mounting holes 134, 135. Thus, the retention member 103 with the partitioning member 102 retained therein is attached to the adjustment member 104.

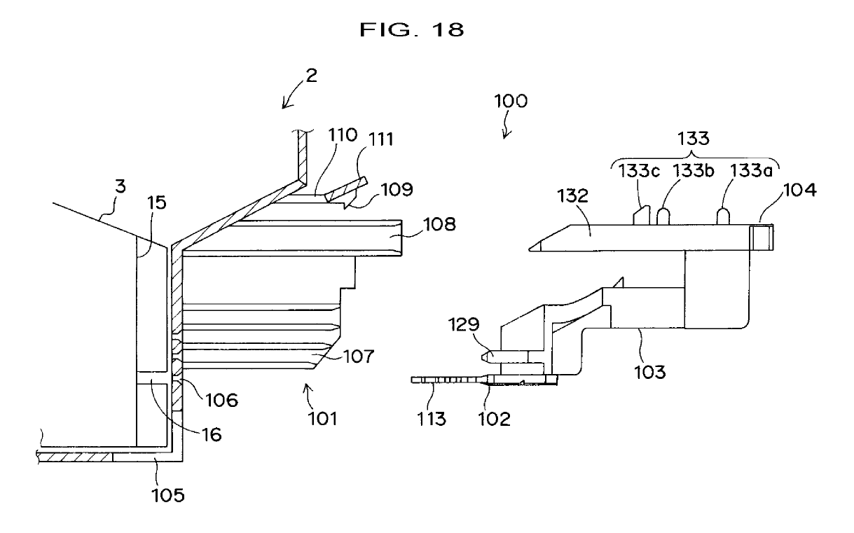

Next, as shown in FIG. 18, the pair of the guide edges 132 of the adjustment member 104, to which the retention member 103 retaining the partitioning member 102 is attached, are brought into engagement with the pair of the guide grooves 108 of the closure member 101 of the cassette body 2 and the adjustment member 104 is slid and pushed toward the rotor 3. Then, the pair of the projection tabs 129 of the retention member 103 are slid to and then engaged with one of the guide grooves 107 of the closure member 101. Further, the partitioning portion 103 of the partitioning member 102 is inserted to one of the slits 106 of the closure member 101 and then enters the guide groove 15 and the circumference groove 16 of the rotor 3 at a suitable depth. While the adjustment member 104 is slid, the engaging claws 109 of the pair of the elastic pieces 110 of the closure member 101 sequentially climb over the stopper 133c, the second engaging projection portion 133b and the first engaging projection portion 133a then engages the first engaging projection portion 133a, thus positioning the adjustment member 104 in the advance position.

In case of demounting the rotor 3 for purposes of cleaning or replacement, it is difficult to demount the rotor from such a state that the partitioning portion 103 of the partitioning member 102 enters the circumference groove 16. Thus, if the adjustment member 104 is grasped and pulled back it in a direction away from the rotor 3, then the engaging claws 109 of the elastic pieces 110 climb over the first engaging projection portion 133a and then cross over the second engaging projection portion 133b and finally abuts the stopper 133c. Thus, the adjustment member 103 can be set to the retreat position. Since the partitioning portion 103 of the partitioning member 102 is retreated from the circumference groove 16, the rotor 3 can be demounted.

In case of demounting the adjustment member 104 from the closure member 101 in order to further adjust the entrance depth and the height of the partitioning member 102, the pressing portion 111 of the elastic pieces 110 of the closure member 101 is pushed obliquely upward. By doing so, the engaging claws 109 of the pair of the elastic pieces 110 are disengaged from the stopper 133c and thus the adjustment member 104 can be demounted. The subsequent adjustment for the partitioning member 102 is as described above.

The fifth embodiment also employs the structure for preventing erroneous mounting of the retention member 103 in a right and left reversed manner. In the state shown in FIG. 17, the first projection portion 127 and the second projection portion 128 of the retention member 103 engage the first mounting hole 134 and the second mounting hole 135 respectively without any interference. However, if it is mounted in a right and left reversed manner, then the first projection portion and the second projection portion would interfere with the first mounting hole 134 and the second mounting hole 135. Accordingly, it must be inevitably mounted at a normal state.

Further, similar to the third embodiment, the fifth embodiment also employs the structure for preventing rattling of the partitioning member 102. That is, when the partitioning member 102 is mounted as shown in FIG. 17, the first engaging portion 116 and the second engaging portion 117 of the partitioning member 102 engage the first engaged portion 125 and the second engaged portion 126 of the retention member 103 in two places. Thus, the position of the retention member 102 is fixed and said rattling is eliminated. Accordingly, the tablets can be reliably dispensed one at a time.

Descriptions are made below as to embodiments of the tablet cassette having the rotor according to the present invention with reference to the accompanying drawings.

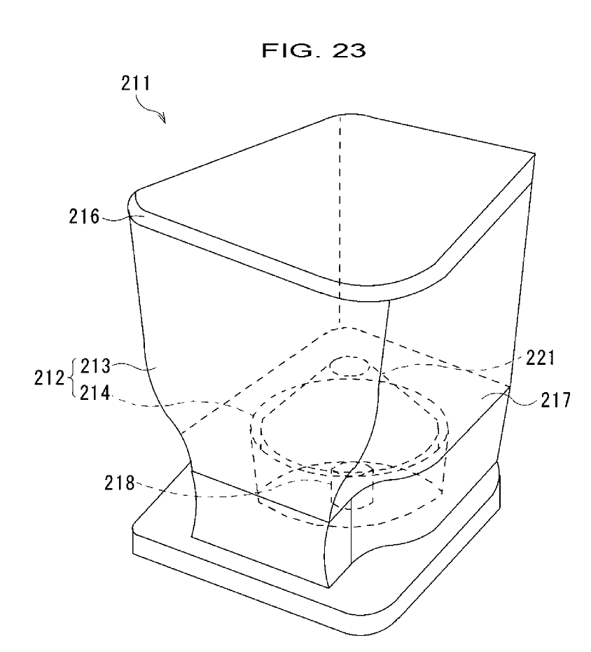

FIG. 23 is a perspective view of a tablet cassette 211 according to an embodiment of the present invention, wherein the rotor is demountable. The tablet cassette 211 is a device that is mounted to the cassette mounting portion (motor base) of the tablet storing and dispensing apparatus (not shown) and dispenses a required number of contained tablets in accordance with a prescription data.

The tablet cassette 211 comprises a cassette body 212 and a rotor 221 that is rotatably disposed on an inside bottom of the cassette body 212.

The cassette body 212 is a bottomed container that is open upwardly. An upper section of the cassette body 212 is a tablet receiving section 213, while a lower section is a rotor housing section 214. The upper opening of the cassette body 212 is closed by a cover 216 that is openable and closable. The tablet receiving section 213 receives tablets on the rotor housing section 214. The rotor housing section 214 comprises a circular concave portion formed in a bottom portion 217 of the cassette body 212. A bottom wall of the rotor housing section 214 is provided with a drive shaft 218 that is connected to an output gear of a motor provided in the cassette mounting portion of the tablet storing and dispensing apparatus. Further, a side wall of the rotor housing section 214 faces toward an outer peripheral surface of the rotor 221 disposed in the rotor housing section 214.

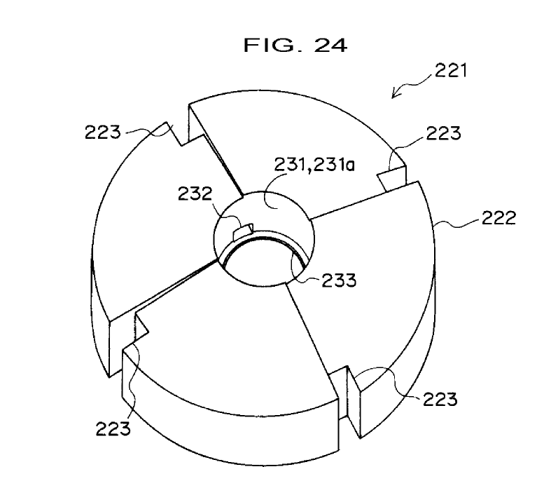

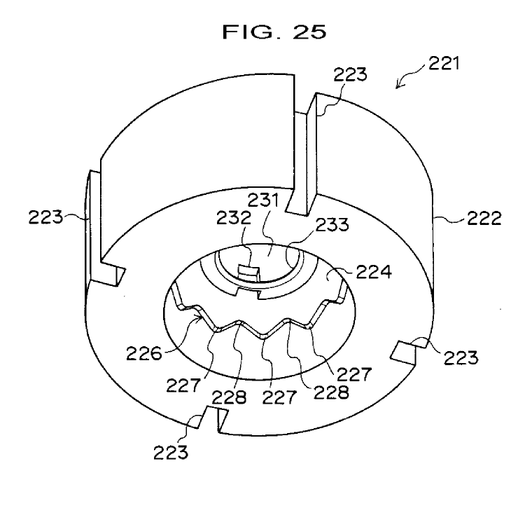

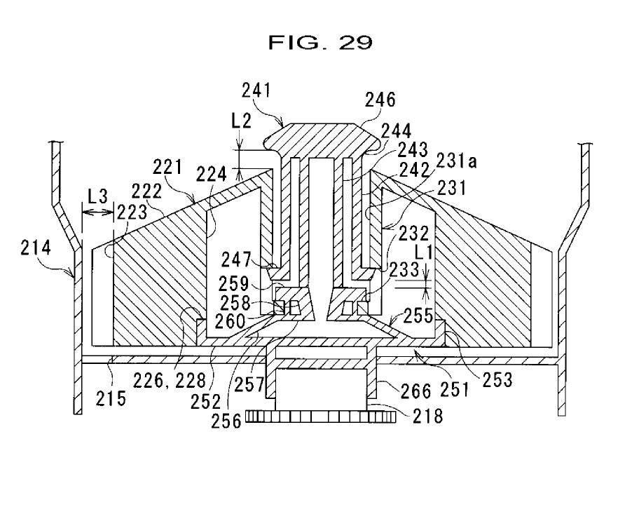

The rotor 221 is disposed in the rotor housing section 214 of the cassette body 212 and is rotatably driven as coupled to the drive shaft 218 through fitting. As shown in FIGS. 24 and 25, the rotor 221 has a substantially cylindrical rotor body 222 having a closed top. The top surface of the rotor body 222 has a conical shape. An outer peripheral surface of the rotor body 222 is formed with a plurality of guide grooves 223, which extend in an axial direction, at an equal spacing along a circumferential direction. Further, a tablet outlet 215 for dispensing of the tablets located in the guide groove 223 is provided in a bottom of the rotor housing section 214 below the guide groove 223 (see FIG. 29).

An inner cylindrical portion 231 is formed around a central axis of the rotor body 222 as extending downwardly from a top side. An inner surface of the inner cylindrical portion 231 is a center bore 231a. An annular flange 233 and a cutout portion 232 are formed in a lower side of the inner cylindrical portion 231. The flange 233 projects radially inwardly. The cutout portion 232 is above the flange 233 and is cut out such that a rectangular hole is open when viewed from front. An inner peripheral surface 224 is formed further radially outwardly than the inner cylindrical portion 231 of the rotor body 222. Further, an engagement portion 226 is formed in the inner peripheral surface 224 by being cut out radially outwardly from the inner peripheral surface 224. The engagement portion 226 is disposed below the flange 233. Further, the engagement portion 226 is provided with convex sections 227 and concave sections 228 that are alternately continuous in the circumferential direction of the rotor 221.

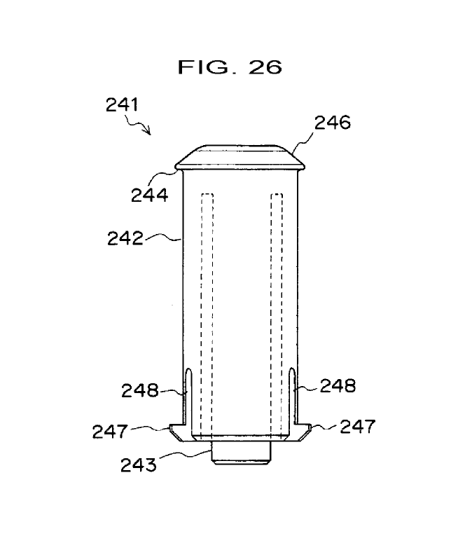

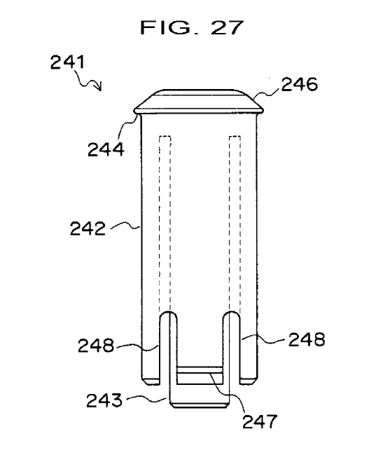

As shown in FIG. 29, a cap 241 is attached to the inner cylindrical portion 231 of the rotor 221. As shown in FIGS. 26 and 27, the cap 241 includes: a cylindrical outer frame 242 having a closed upper end and an open lower end; and a pressing portion 243 formed inside the outer frame 242 and extending further downwardly than the lower end of the outer frame 242. The upper end of the outer frame 242 is formed with: a flange portion 244 extending radially outwardly; and a frustoconical lid portion 246 extending upwardly from the flange portion 244. The pressing portion 243 extends downwardly from an underside of the lid portion 246. The lower edge of the outer frame 242 is formed with a pair of projection portions 247 projecting radially outwardly. Slits 248 are provided on either side of the projection portion 247, thus imparting elasticity to the projection portion 247.

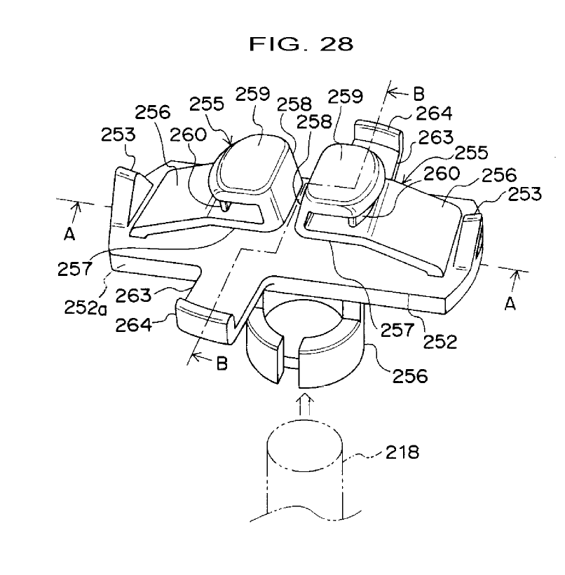

Further, the rotor 221 is attached to the drive shaft 218 of the cassette body 212 through a securement member 251 according to the present invention (see FIG. 29). As shown in FIG. 28, the securement member 251 comprises the following: a rectangular base portion 252; a pair of projection portions 253 extending upwardly from both ends of the base portion 252 and having a triangular shape when view from front; a pair of flexible portions 255 extending from a surface of the base portion 252 in the vicinity of the projection portion 253 toward a center of the base portion 252; and a pair of arm portions 263 extending outwardly from a side edge 255a of the base portion 252. Each flexible portion 255 comprises the following: an inclined surface section 256 standing from the surface of the either end of the base portion 252 and extending obliquely upward toward the center of the base portion 252; a horizontal surface section 257 adjoined to the inclined surface section 256 and extending horizontally toward the center of the base portion 252; a standing section 258 extending obliquely upward at an acute angle from the horizontal surface section 257; an engagement surface section 259 extending horizontally from the standing section 258 toward the end of the base portion 252 adjacent thereto; and a vertical wall 260 extending vertically from the vicinity of an end of the engagement surface section 250 between the engagement surface section 259 and the horizontal surface section 257. The arm portion 263 extends outwardly from the side edge 252a, which is offset from the center line of the base portion 252 toward one of the projection portions 253. The arm portion 263 has an upthrust portion 264 standing upward from its end. A fitting tube portion 266 for fitting with the drive shaft 218 is provided in a backside of the base portion 252.

Next, descriptions are made as to the operation of mounting the rotor 221 to the drive shaft 218 and demounting the same therefrom.

First, the fitting tube portion 266 of the securement member 251 is fitted with the drive shaft 218 and is fixed thereto. Typically, the securement member 251 is not demounted from the drive shaft 218, but is demounted only when cleaning the cassette body 211.

To mount the cap 241 to the rotor 221, the outer frame 242 is inserted into the inner cylindrical portion 231 from its lower end. Then, the projection portion 247 of the outer frame 242 engages an upper surface of the cutout portion 232, thus mounting the cap 241 to the rotor 221.

The rotor 221 with the cap 241 mounted thereto is attached to the securement member 251 fixed to the drive shaft 218. As the rotor 221 is fitted to the securement member 251 with the inner peripheral surface 224 of the rotor 221 in slide contact with both ends of the securement member 251, the upthrust portion 264 first abuts the convex section 227 of the engagement portion 226. As the rotor is further fitted to the securement member, the projection portion 253 of the securement member 251 engages the concave section 228 of the engagement portion 226 and, at the same time, the engagement surface section 259 located outwardly of the vertical wall 260 climbs over the flange 233 and then engages an upper surface of the flange 233. Thus, the rotor 221 can be attached to the securement member 251.

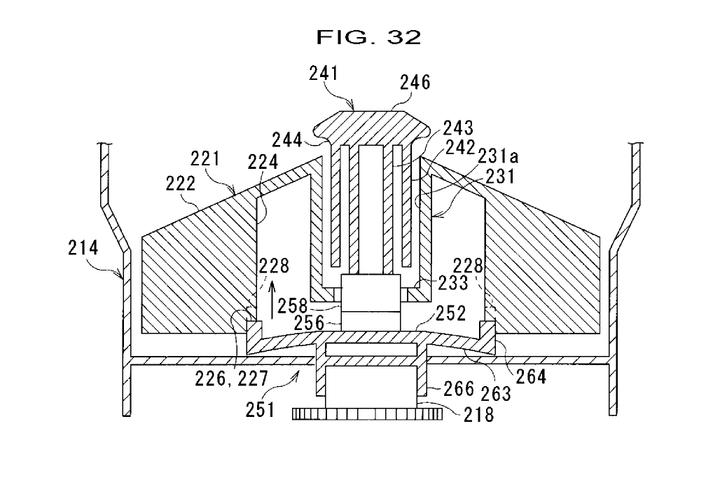

As shown in FIG. 32, in a state where the rotor 221 is mounted to the securement member 251, the arm portion 263 elastically deforms and upwardly urges the rotor 221 via the engagement portion 226. Since the engagement surface section 259 engages the upper surface of the flange 233, the rotor 221 is prevented from being upwardly separated from the securement member 251. Further, since the projection portion 253 is fitted to the concave section 228 of the rotor body 222, if the securement member 251 is rotated under the rotation of the drive shaft 218, the rotor 221 can also rotate simultaneously. As the rotor 221 is rotated, the tablets, which have been introduced from the tablet receiving section 213 to the guide groove 223 of the rotor 221, are dispensed from the tablet outlet 215. A spacing L3 is defined between an inside surface of the guide groove 223 and the side surface of the rotor housing section 214. The spacing L3 may vary depending upon the size of the tablets to be dispensed. The spacing L3 is somewhat greater than a minor axis of the tablet to be dispensed. Thus, a powder is prone to be made due to rubbing between tablets and the side surface of the rotor housing section 214.

An upper surface of the engagement surface section 259 is in abutment with the lower end of the pressing portion 243. Thus, a spacing L1 is defined between the a lower surface of the projection portion 247 and the upper surface of the engagement surface section 259 and a spacing L2 is defined between a lower edge of the lid portion 246 and the upper end of the rotor body 222. Thus, the cap 241 can be moved downward in the inner cylindrical portion 231.

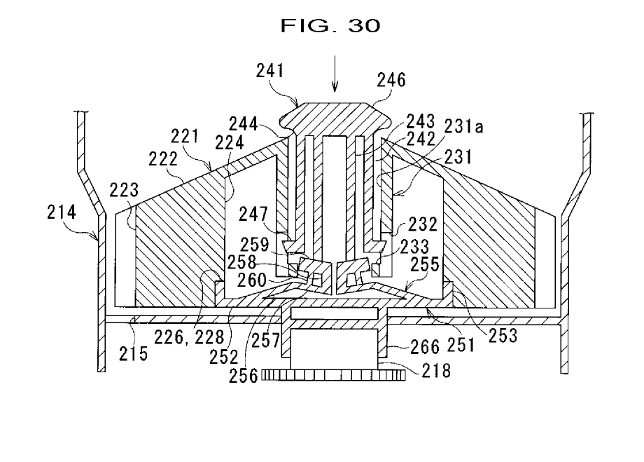

To demount the rotor 221 from the securement member 251, as shown in FIG. 30, the upper surface of the lid portion 246 of the cap 241 is pressed downward. Then, the cap 241 is moved downward in the inner cylindrical portion 231 and the pressing portion 243 presses down a radially inward end portion of the engagement surface section 259. Such a pressure force is transmitted from the standing section 258 or the vertical wall 260 to the horizontal surface section 257 and then the inclined surface section 256, thus elastically deforming the inclined surface section 256 downwardly. As a result, the flange 233 and the engagement surface section 259 are disengaged from each other and the rotor 221 goes into the state wherein it is demountable from the securement member 251. At this time, since an elastic force of the arm portion 263 urges the rotor 221 upwardly, the rotor can be demounted from the securement member 251 without application of a force to the rotor 221. Accordingly, the rotor 221 can be easily demounted from the securement member 251.

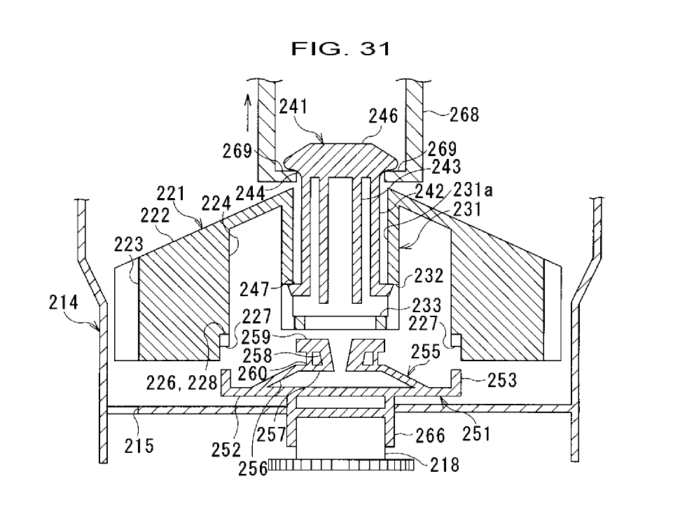

Further, as shown in FIG. 31, the rotor 221 demounted from the securement member 251 may be lifted from the rotor housing section 214 by means of the cap 241. Specifically, a cylindrical holder 268 is used. A projection 269 formed at a lower end of the holder 268 is brought into engagement with the flange portion 244 of the lid portion 241 and then the holder 268 is pulled up. In this way, the cap 241 as well as the rotor 221 in engagement with the projection portions 247 of the cap 241 can be easily lifted from the rotor housing section 214. Further, there is no need to turn the tablet cassette 211 upside down in order to demount the rotor 221, thus preventing the powder from falling from the bottom of the tablet cassette 211 or adhering to a human's hand.

To demount the cap 241 from the rotor 221, the projection portion 247 is pressed inward, thus releasing the engagement between the cutout portion 232 and the projection portion 247. Then, the cap 241 can be demounted from the inner cylindrical portion 231 by grasping the lid portion 246 and pulling out the same from the rotor 221.

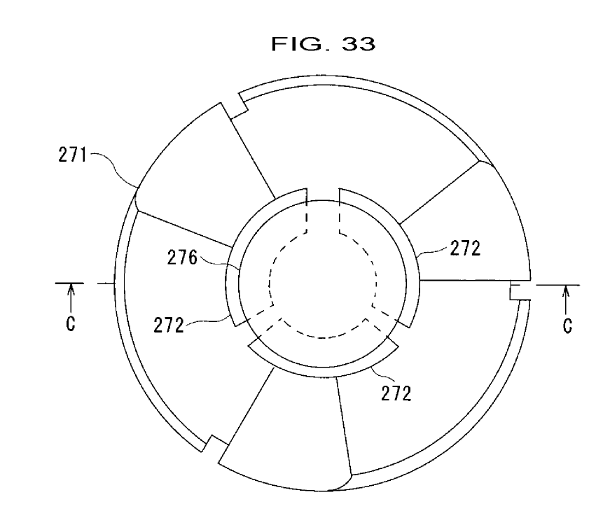

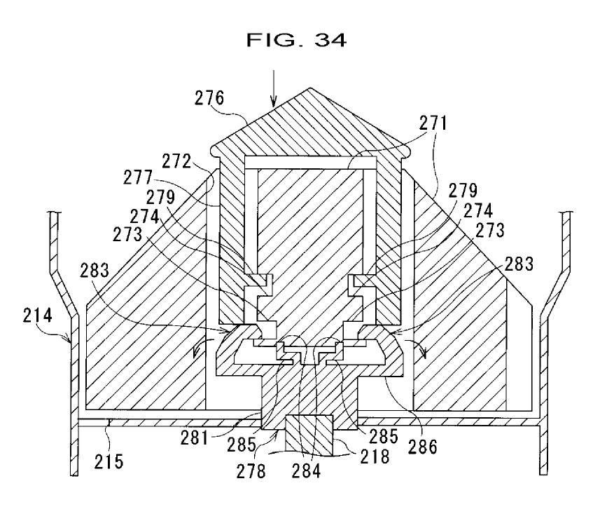

FIGS. 33 and 34 show a rotor 271 according to another embodiment of the present invention. The rotor 271 has a cylindrical shape and a top surface thereof is formed in a conical shape. Three holes 272, which are pierced from a top to an underside of the rotor, are provided coaxially with a central axis of the rotor 271 at an equal spacing along a circumferential direction. A lower cutout portion 273, which is concavely cut out in a radially inward direction, is formed at a lower end of an inner peripheral surface of each hole 272. An upper cutout portion 274, which has the same shape as the lower cutout portion 273, is formed above the lower cutout portion. Further, three pressing portions 277, which constitute legs of the cap 275, are inserted to the holes 272 respectively. A projection portion 279 projecting radially inwardly is provided on an inner periphery of the pressing portion 277. The cap 276 is attached to be movable downwardly along the cutout portion 274 as the projection portion 279 is in engagement with the cutout portion 274. A securement member 278 has a base portion 281 having a T-shaped cross-section, a flexible portion 283 and an arm portion 285. The base portion 281 is fitted with the drive shaft 218. The flexible portion 283 extends radially outwardly from either end of the base portion 281 and then extends obliquely upward toward an inside. An end portion of the flexible portion 283 engages the lower cutout portion 273. The arm portion 285 extends upward from a top of the base portion 281. The arm portion 285 engages a groove portion 284 formed in an underside of the rotor 271, thus rotationally driving the rotor 271. Further, the arm portion 285 elastically deforms and thus upwardly urges the rotor 271.

To demount the cap 276 from the rotor 271, a top of the cap 276 is pressed downward. Then, the pressing portion 277 presses the flexible portion 283 and the flexible portion 283 elastically deforms in a direction indicated by an arrow in the FIG. 34, thereby releasing the engagement between the flexible portion 283 and the lower cutout portion 273. Thus, the rotor 271 and the cap 276 can be easily demounted from the rotor housing section 214.

The present invention should not be limited to the foregoing embodiments and various modifications may be made.

As for the engagement portion 226 of the rotor 221, it is formed in a wavy shape when viewed from front, but is not particularly limited as long as it may engage the upthrust portion 264 as well as the projection portion 253 of the securement member 251. Similarly, the shapes of the upthrust portion 264 and the projection portion 253 of the securement member 251 are not particularly limited as long as they may engage the engagement portion 226 of the rotor 221.

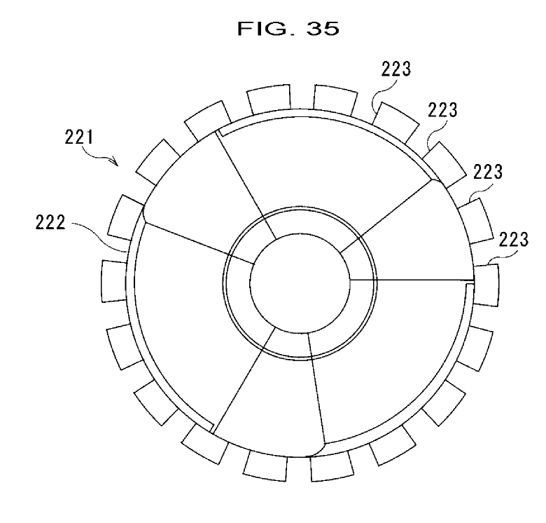

As for the guide grooves 223 of the rotor 221, its number is not limited to four. As shown in FIG. 35, the rotor 221 wherein a large number of the guide grooves 223 are formed at an equal spacing along the circumferential direction of the rotor body 222 may be employed.

Further, the flexible portion 255 of the securement member 251 includes the inclined surface section 256, the horizontal surface section 257, the standing section 258, the engagement surface section 259 and the vertical wall 260. However, the flexible portion is not particularly limited as long as it may engage the rotor 221 and its engagement may be released by pressure of the pressing portion 243.

The arm portion 263 extends outwardly from the side edge 252a, which is offset from the center line of the base portion 252 toward one of the projection portions 253, outwardly of said projection portion 253. However, as long as the securement member 251 may be formed, the configuration that the arm portion extends from the side edge 252a on the center line may be employed.

1. A tablet cassette, comprising:
a cassette body formed with a tablet receiving section for receiving a tablet;
a rotor rotatably driven and disposed in a bottom of the tablet receiving section of the cassette body, an outer peripheral surface of the rotor being formed with a plurality of guide grooves extending in an axial direction; and
a partitioning member attached to the cassette body, the partitioning member entering the guide groove of the rotor that comes to a position where the guide groove communicates with a tablet outlet provided in the cassette body,
wherein the partitioning member has a partitioning portion comprising a plurality of elastic bristles,
wherein a side wall of the cassette body is formed with a plurality of slits, through which at least one of the elastic bristles penetrates, along a circumferential direction of the rotor, the slits extending in the axial direction of the rotor, and
wherein the partitioning member is movable along the slit with the elastic bristle penetrating through the slit.

2. The tablet cassette of claim 1, wherein the side wall of the cassette body is formed with an opening facing toward the outer peripheral surface of the rotor and a closure member formed with the slits closes the opening.

3. The tablet cassette of claim 2, wherein a retention member movably retaining the partitioning member in a radial direction of the rotor is provided,
wherein the closure member is provided with a support portion supporting the retention member,
wherein the partitioning member is formed with an engaging portion, and
wherein the retention member is formed with an engaged portion which the engaging portion of the partitioning member engages, thereby allowing suitable positioning in the radial direction of the rotor.

4. A tablet cassette, comprising:
a cassette body formed with a tablet receiving section for receiving a tablet;
a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and
a partitioning member attached to the cassette body, the partitioning member entering the guide groove of the rotor that comes to a position where the guide groove communicates with a tablet outlet provided in the cassette body,
wherein a side wall of the cassette body is formed with an opening facing toward the outer peripheral surface of the rotor,
wherein a plurality of closure pieces divided in the axial direction of the rotor close the opening,
wherein one of the plurality of the closure pieces is formed with a slit to which a partitioning portion of the partitioning member is inserted, the slit extending in the circumferential direction of the rotor, and
wherein the closure piece with the slit formed therein is replaced with another closure piece and the partitioning portion of the partitioning member is inserted to the slit of the closure piece with the slit formed therein, thereby changing an attachment position.

5. The tablet cassette of claim 4, wherein a retention member movably retaining the partitioning member in a radial direction of the rotor is provided,
wherein the closure member is provided with a support portion supporting the retention member,
wherein the partitioning member is formed with an engaging portion, and
wherein the retention member is formed with an engaged portion which the engaging portion of the partitioning member engages, thereby allowing suitable positioning in the radial direction of the rotor.

6. A tablet cassette, comprising:
a cassette body formed with a tablet receiving section for receiving a tablet;
a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and
a partitioning member attached to the cassette body, the partitioning member entering the guide groove of the rotor that comes to a position where the guide groove communicates with a tablet outlet provided in the cassette body,
wherein a side wall of the cassette body is formed with an opening facing toward the outer peripheral surface of the rotor,
wherein a plurality of closure pieces divided in the axial direction of the rotor and a single partitioning member close the opening, and
wherein the partitioning member is replaced with one of the closure pieces, thereby changing an attachment position.

7. The tablet cassette of claim 6, wherein both side edges of the opening are formed with a groove, which both ends of the plurality of the closure pieces engage, and the partitioning member is insertable along the groove in a radial direction of the rotor.

8. The tablet cassette of claim 7, wherein both ends of the partitioning member are inserted and attached to a first projecting portion and a second projecting portion, the first and second projecting portions being formed in a U-shaped cross-section by forming a groove therein,
wherein both surfaces of the closure piece are formed with a ridge extending perpendicularly to an insertion direction of the closure piece, and
wherein opposing surfaces of the grooves of the first projecting portion and the second projecting portion are formed with a plurality of engaging grooves, which the ridge engages, along the insertion direction of the closure piece.

9. The tablet cassette of claim 6, wherein a plurality of the partitioning members, the respective partitioning portions of which have a different length, are prepared, and
wherein the partitioning member having the partitioning portion having a length according to a size of the tablet to be received in the cassette body is selected and attached.

10. The tablet cassette of claim 6, wherein a lid member is openably and closably attached to the cassette body, the lid member closing a further outside of the plurality of the closure pieces and the partitioning member which are attached to the opening, and
wherein a backside of the closure piece is formed with a projection portion that interferes with an inner surface of the lid member when the closure piece is attached in a state other than a normal state in a right and left reversed manner and the lid member is closed.

11. The tablet cassette of claim 8, wherein a backside of the closure piece is formed with a knob portion,
wherein a length of a first shoulder portion, which ranges from one end of the closure piece to one end of the knob portion, is different from a length of a second shoulder portion, which ranges from an opposite end of the closure piece to an opposite end of the knob portion,
wherein the first projecting portion of the partitioning member has a same length as the length of the first shoulder portion of the closure piece and the second projecting portion of the partitioning member has a same length as the length of the second shoulder portion of the closure piece, and
wherein the first projecting portion and the second projecting portion of the partitioning member interfere with the knob portion of an adjacent closure piece when the partitioning member is attached in a state other than a normal position in a right and left reversed manner.

12. The tablet cassette of claim 8, wherein backsides of the first projecting portion and the second projecting portion of the partitioning member are formed with a projection or recess,
wherein a lid member is openably and closably attached to the cassette body, the lid member closing a further outside of the plurality of the closure pieces and the partitioning member which are attached to the opening, and
wherein an inner surface of the lid member is formed with a recess or projection that engages the projection or recess of the partitioning member.

13. A tablet cassette, comprising:
a cassette body formed with a tablet receiving section for receiving a tablet;
a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and
a partitioning member attached to the cassette body, the partitioning member entering the guide groove of the rotor that comes to a position where the guide groove communicates with a tablet outlet provided in the cassette body,
wherein a side wall of the cassette body is formed with a plurality of slits, to which a partitioning portion of the partitioning member is inserted, along the axial direction of the rotor, the slits extending in the circumferential direction of the rotor, and
wherein the partitioning portion of the partitioning member is inserted to one of the plurality of the slits, thereby changing an attachment position.

14. The tablet cassette of claim 13, wherein both side edges of the opening are formed with as many grooves as the slits and both ends of the partitioning member engage the groove, and
wherein the partitioning member is insertable along the groove in a radial direction of the rotor.

15. The tablet cassette of claim 14, wherein both ends of the partitioning member are inserted and attached to a first projecting portion and a second projecting portion, the first and second projecting portions being formed in a U-shaped cross-section by forming a groove therein,
wherein both surfaces of the partitioning member are formed with a ridge extending perpendicularly to an insertion direction of the partitioning member, and
wherein opposing surfaces of the grooves of the first projecting portion and the second projecting portion are formed with a plurality of engaging grooves, which the ridge engages, along the insertion direction of the partitioning member.

16. The tablet cassette of claim 13, wherein a plurality of the partitioning members, the respective partitioning portions of which have a different length, are prepared, and
wherein the partitioning member having the partitioning portion having a length according to a size of the tablet to be received in the cassette body is selected and attached.

17. The tablet cassette of claim 15, wherein a protrusion portion is provided between the adjacent slits of the cassette body,
wherein a length of a first shoulder portion, which ranges from one side edge of the cassette body to one end of the protrusion portion, is different from a length of a second shoulder portion, which ranges from an opposite side edge of the cassette body to an opposite end of the protrusion portion,
wherein the first projecting portion of the partitioning member has a same length as the length of the first shoulder portion of the cassette body and the second projecting portion of the partitioning member has a same length as the length of the second shoulder portion of the cassette body, and
wherein the first projecting portion and the second projecting portion of the partitioning member interfere with the protrusion portion of the cassette body when the partitioning member is attached in a state other than a normal position in a right and left reversed manner.

18. The tablet cassette of claim 15, wherein backsides of the first projecting portion and the second projecting portion of the partitioning member are formed with a projection or recess,
wherein a lid member is openably and closably attached to the cassette body, the lid member closing a further outside of the slit of the cassette body, and
wherein an inner surface of the lid member is formed with a recess or projection that engages the projection or recess of the partitioning member.

19. A tablet cassette, comprising:
a cassette body formed with a tablet receiving section for receiving a tablet;
a rotor rotatably driven and disposed in a bottom of the tablet receiving section of the cassette body, an outer peripheral surface of the rotor being formed with a plurality of guide grooves extending in an axial direction and a circumference groove extending in a circumferential direction; and
a partitioning member attached to the cassette body, the partitioning member entering the guide groove of the rotor that comes to a position where the guide groove communicates with a tablet outlet provided in the cassette body,
wherein a side wall of the cassette body is formed with a plurality of slits, to which a partitioning portion of the partitioning member is inserted, along the axial direction of the rotor, the slits extending in the circumferential direction of the rotor,
wherein the tablet cassette further comprises:
a retention member configured to retain the partitioning member and to adjust a retention position of the partitioning member so as to change a entrance depth of the partitioning member to the guide groove of the rotor, and
an adjustment member configured to attach the retention member retaining the partitioning member and to adjust an attachment position of the partitioning member such that the partitioning portion of the partitioning member is inserted to one of the plurality of the slits to change a height of the partitioning member.

20. The tablet cassette of claim 19, wherein the partitioning member is provided with at least one pair of engaging portions extending in the axial direction of the rotor, and
wherein the retention member is formed with a plurality of engaged portions, which said at least one pair of engaging portions engage, along a direction perpendicular to the axial direction of the rotor.

21. The tablet cassette of claim 19, wherein the side wall of the cassette body is formed with as many pairs of support grooves as the plurality of the slits, the support grooves extending in a direction perpendicular to the axial direction of the rotor, and the retention member is provided with a pair of projection tabs that slidably engage the support groove of the cassette body.

22. The tablet cassette of claim 19, wherein the retention member is provided with a projection portion and the adjustment member is formed with a plurality of mounting holes, which the projection portion of the retention member engages, along the axial direction of the rotor.

23. The tablet cassette of claim 22, wherein the projection portion of the retention member comprises first and second projection portions having a different shape,
wherein the mounting hole of the adjustment member comprises a first mounting hole and a second mounting hole, which the first projection portion and the second projection portion engage respectively, and
wherein the first projection portion and the second projection portion engage the first mounting hole and the second mounting hole only when the retention member is in a predetermined orientation.

24. The tablet cassette of claim 19, wherein the side wall of the cassette body is formed with a pair of guide grooves that extend in a direction perpendicular to the axial direction of the rotor,
wherein the adjustment member is provided with a pair of guide edges that slidably engage the guide groove, and
wherein the adjustment member is slidable relative to the cassette body between: an advance position where the partitioning member enters the guide groove of the rotor; and a retreat position where the partitioning member is retreated from the guide groove.

25. The tablet cassette of claim 19, wherein the side wall of the cassette body is provided with an elastic piece having an engaging claw at a tip end, and
wherein the adjustment member is provided with an engaging portion, which the engaging claw of the elastic piece engages when the adjustment member is in the advance position and the retreat position.

26. The tablet cassette of claim 1, wherein the rotor is replaceable.

27. A tablet cassette, comprising:
a cassette body formed with a tablet receiving section for receiving a tablet; and
a rotor rotatably driven by a drive shaft disposed in a bottom of the tablet receiving section of the cassette body, the rotor having an engagement portion extending radially,
wherein the tablet cassette further comprises:
a securement member fixed to the drive shaft, the securement member including: a drive portion transmitting a power of the drive shaft to the rotor to rotate the rotor; a flexible portion engaging the engagement portion; and an arm portion abutting the rotor in an elastically deformed state; and
a cap attached to the rotor and movable in an axial direction of the rotor, the cap having a pressing portion that is downwardly pressed to thus press the flexible portion of the securement member,
wherein when the cap is downwardly pressed, the pressing portion presses the flexible portion to thereby release an engagement between the flexible portion and the engagement portion and an elastic force of the arm portion urges the rotor upwardly.

28. The tablet cassette of claim 27, wherein the drive portion of the securement member comprises a projection portion extending upwardly from either end of the securement member,
wherein the engagement portion formed in the rotor comprises a concave section and a convex section that are alternately continuous, and
wherein the projection portion engages the concave section.

29. The tablet cassette of claim 28, wherein the arm portion of the securement member extends outwardly from a side edge of the securement member and has an upthrust portion upwardly standing from an end portion,
wherein a pressed portion formed in the rotor is the convex section of the engagement portion of the rotor, and
wherein the upthrust portion thrusts up the convex section.

30. The tablet cassette of claim 27, wherein a center of the rotor is formed with a hole,
wherein the engagement portion of the rotor comprises a flange protruding inwardly from a lower inner periphery of the hole, and
wherein the pressing portion of the cap is formed in a lower end of a cylindrical portion that is provided coaxially with an axis of the rotor.

31. The tablet cassette of claim 27, wherein a plurality of holes are formed around a center of the rotor,
wherein the engagement portion of the rotor comprises a lower cutout portion formed at a lower edge of an inner peripheral surface of the hole, and
wherein the pressing portion of the cap is formed at lower ends of a plurality of legs of the cap, the legs being inserted to the rotor.

32. The tablet cassette of claim 27, wherein an upper end portion of the cap is provided with a flange portion extending radially outwardly, and
wherein the tablet cassette further comprises a holder that is formed with a projection engaging the flange portion from below.

33. The tablet cassette of claim 4, wherein the rotor is replaceable.

34. The tablet cassette of claim 6, wherein the rotor is replaceable.

35. The tablet cassette of claim 13, wherein the rotor is replaceable.

36. The tablet cassette of claim 19, wherein the rotor is replaceable.
